(19) United States
(12) Patent Application Publication
(10) Pub. No.: US 2025/0104519 A1
(43) Pub. Date: Mar. 27, 2025

(54) WIDE AREA PROGRESSIVE BONUS SYSTEM AND METHOD WITHIN A MOBILE CASINO GAMING APPLICATION

(71) Applicant: Aristocrat Technologies, Inc., Las Vegas, NV (US)

(72) Inventors: Charles Hiten, Boca Raton, FL (US); Karthick Sundararaman, Redmond, WA (US); Jennifer Potokar, Henderson, NV (US); Michelle Raman, Las Vegas, NV (US); Tammy Rambo, Las Vegas, NV (US); Alisa Mirabal, Henderson, NV (US); Binh Nguyen, Reno, NV (US)

(21) Appl. No.: 18/893,417

(22) Filed: Sep. 23, 2024

Related U.S. Application Data
(60) Provisional application No. 63/585,498, filed on Sep. 26, 2023.

(51) Int. Cl. G07F 17/32; G06Q 20/36

(52) U.S. Cl. CPC G07F 17/3258; G06Q 20/36; G07F 17/323; G07F 17/3272; G06Q 2220/00

(57) ABSTRACT

A progressive bonus award system integrated within a mobile application is disclosed. Upon receiving data of a transaction performed by a player using the mobile application and determining that the player is participating in a progressive bonus award associated with the mobile application, a determination is made whether to issue a ticket to the player for the transaction performed by the player. The ticket includes a ticket identifier. An additional value is added to the progressive bonus award based at least in part on the transaction performed by the player to progressively increase the progressive bonus award during a promotional time period, and at the end of the promotional time period, a winning ticket identifier is randomly drawn and verified that the winning ticket identifier matches the ticket identifier of the ticket issued to the player and displayed within the mobile application along with an awarded amount to the player.

### CROSS-REFERENCE TO RELATED APPLICATIONS

This application claims the benefit of priority of U.S. Provisional Application No. 63/585,498, filed Sep. 26, 2023, titled “WIDE AREA PROGRESSIVE BONUS SYSTEM AND METHOD WITHIN A MOBILE APPLICATION,” the contents and disclosures of which are hereby incorporated herein by reference in their entirety.

### TECHNICAL FIELD

The field of this disclosure relates generally to electronic gaming, and more specifically, to funding technology that provides for players to seamlessly transition from one gaming ecosystem to another gaming ecosystem. More specifically, the field of disclosure relates to network-based systems and methods for tracking and providing a wide area network progressive bonus award to eligible users of a specific mobile application wherein eligibility is determined by applying predefined rules to tasks performed with the specific mobile application.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In some cases, mobile applications are used by players of EGMs as part of interacting with the EGMs. Use of these mobile applications can be beneficial to both players, casino operators and game designers. It is desirable to have a mobile application that can be used to facilitate game play on EGMs or other gaming devices while also providing gamification tools that reward the players for using the mobile applications.

### BRIEF DESCRIPTION

In one aspect, a progressive bonus award system that is integrated within a mobile application is disclosed. The progressive bonus award system includes a memory device storing instructions and a game controller including a processor configured to execute the instructions stored in the memory device, which, when executed, cause the game controller to: (i) receive, from a wallet orchestrator associated with the mobile application, data of a transaction performed by a player of a plurality of players using the mobile application executing on a user computing device of the player; (ii) list the transaction data in a digital ledger associated with the mobile application, the transaction data including player information of the player; (iii) in response to determining that the player is participating in a progressive bonus award associated with the mobile application, determine whether to issue a ticket to the player for the transaction performed by the player, the ticket including a ticket identifier and providing the player a chance to win the progressive bonus award; (iv) in response to issuing a ticket to the player for the transaction performed by the player, add an entry to the digital ledger including ticket information of the issued ticket, the entry being linked to the player; (v) add an additional value to the progressive bonus award based at least in part on the transaction performed by the player to progressively increase the progressive bonus award during a promotional time period; (vi) at the end of the promotional time period, randomly draw a winning ticket identifier of a winning ticket and verify that the winning ticket identifier matches the ticket identifier of the ticket issued to the player; and (vii) provide, via the mobile application, notification of the winning ticket to at least the player

In another aspect, a computer-implemented method for providing a progressive bonus award system integrated within a mobile application implemented using at least one processor with at least one memory, including: (i) receiving, from a wallet orchestrator associated with the mobile application, data of a transaction performed by a player of a plurality of players using the mobile application executing on a user computing device of the player; (ii) listing the transaction data in a digital ledger associated with the mobile application, the transaction data including player information of the player; (iii) in response to determining that the player is participating in a progressive bonus award associated with the mobile application, determining whether to issue a ticket to the player for the transaction performed by the player, the ticket including a ticket identifier and providing the player a chance to win the progressive bonus award; (iv) in response to issuing a ticket to the player for the transaction performed by the player, adding an entry to the digital ledger including ticket information of the issued ticket, the entry being linked to the player; (v) adding an additional value to the progressive bonus award based at least in part on the transaction performed by the player to progressively increase the progressive bonus award during a promotional time period; (vi) at the end of the promotional time period, randomly drawing a winning ticket identifier of a winning ticket and verify that the winning ticket identifier matches the ticket identifier of the ticket issued to the player; and (vii) providing, via the mobile application, notification of the winning ticket to at least the player.

In yet another aspect, one or more non-transitory computer-readable storage media with a plurality of instructions stored thereon that, in response to being executed, cause a game controller to: (i) receive, from a wallet orchestrator associated with the mobile application, data of a transaction performed by a player of a plurality of players using the mobile application executing on a user computing device of the player; (ii) list the transaction data in a digital ledger associated with the mobile application, the transaction data including player information of the player; (iii) in response to determining that the player is participating in a progressive bonus award associated with the mobile application, determine whether to issue a ticket to the player for the transaction performed by the player, the ticket including a ticket identifier and providing the player a chance to win the progressive bonus award; (iv) in response to issuing a ticket to the player for the transaction performed by the player, add an entry to the digital ledger including ticket information of the issued ticket, the entry being linked to the player; (v) add an additional value to the progressive bonus award based at least in part on the transaction performed by the player to progressively increase the progressive bonus award during a promotional time period; (vi) at the end of the promotional time period, randomly draw a winning ticket identifier of a winning ticket and verify that the winning ticket identifier matches the ticket identifier of the ticket issued to the player; and (vii) provide, via the mobile application, notification of the winning ticket to at least the player.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 3 is a diagram that shows examples of components of a system for providing online gaming according to some aspects of the present disclosure.

FIG. 4A illustrates, in block diagram form, an overview of some of the components and services of a universal wallet system (UWS) including a progressive bonus award system (PBAS) according to an example embodiment.

FIG. 4B is a continuation of the block diagram shown in FIG. 4A.

FIG. 4C is a block diagram illustrating exemplary functional and/or logical operations of the UWS shown in FIGS. 4A and 4B.

FIG. 4D is a block diagram of an exemplary ledger system of the UWS according to an exemplary embodiment of the present disclosure.

FIG. 4E is a block diagram of an exemplary ticket management data flow.

FIGS. 5A to 5C illustrate exemplary screenshots or user interfaces of a mobile application used by a player for tracking the progressive bonus award in accordance with some embodiments of the present disclosure.

FIG. 6 is a flowchart illustrating an exemplary method managing the progressive bonus award.

FIG. 7 is a flowchart illustrating an exemplary method for transferring funds to a gaming device using the UWS shown in FIGS. 4A to 4C.

FIG. 8 is a flowchart illustrating an exemplary method for off-site payment card transaction using the UWS shown in FIGS. 4A to 4C.

FIG. 9A illustrates an example overview of certain exemplary components and services of a gaming system including a UWS according to an exemplary embodiment of the present disclosure.

FIG. 9B is a block diagram illustrating exemplary components of the gaming system shown in FIG. 9A that are executed when a user associated with a universal digital wallet starts a session using a physical card at the gaming device according to an exemplary embodiment of the present disclosure.

FIG. 9C is a block diagram illustrating exemplary components of the gaming system shown in FIG. 9A that are executed when a user associated with a universal digital wallet starts a session using a mobile application at the gaming device according to an exemplary embodiment of the present disclosure.

FIG. 9D is a block diagram illustrating exemplary components of the gaming system shown in FIG. 9A that are executed when a user enters an amount to transfer via a mobile application at the gaming device according to an exemplary embodiment of the present disclosure.

FIG. 9E is a block diagram illustrating exemplary components of the gaming system shown in FIG. 9A that are executed when a session is ended by the user removing a card from the gaming device according to an exemplary embodiment of the present disclosure.

FIG. 9F is a block diagram illustrating exemplary components of the gaming system shown in FIG. 9A that are executed when a session is ended using a mobile application at the gaming device according to an exemplary embodiment of the present disclosure.

FIG. 10 is a flowchart illustrating an exemplary method for transferring funds to a gaming device using the system shown in FIGS. 9A-9F.

FIG. 11 is a block diagram illustrating an example computer server according to an embodiment of the present disclosure.

FIG. 12 is a block diagram illustrating an example user computing device according to an embodiment of the present disclosure.

### DETAILED DESCRIPTION

Casino operators and/or other gaming parties offer digital wallets to be used to manage proceeds exchanged as part of gaming. However, these casino digital systems that are used to manage payments, payouts to players, and other financial transactions associated with gaming are generally fragmented, with each manufacturer implementing different proprietary protocols and proprietary payments systems for casino transactions that do not communicate with each other. Thus, there is a need to provide a digital wallet system for the gaming environment that is easy to use by players and allows for a more seamless user experience where the patron's wallet balance is easily accessible across multiple properties while complying with regulations.

In addition, it is desirable to incentivize players to use a particular digital wallet system since there are many different kinds. Thus, it is desirable to create a digital wallet system that also includes and manages a wide area progressive bonus system that can be used by users of the digital wallet system to reward and incentivize use of the digital wallet system.

While digital wallets can significantly enhance the user experience and engagement of players by providing seamless transactions, quick payouts, presenting players with rewards and/or other promotions/offers, permitting tracking of funds and accounts (e.g., linking to loyalty programs), enhanced security (e.g., encryption and authentication (such as fingerprint or facial recognition via mobile devices)), convenience (e.g., players can easily access their funds from their mobile devices, enhancing the overall gaming experience), multi-platform support (e.g., used across various casino platforms), and improved data integration, implementing a wide area progressive bonus system within a digital wallet presents several unique technical problems and challenges.

Wide area progressives span across multiple casino operators, with each operator commonly having different internal systems, and there being no standardized approach to linking such systems. Moreover, the vastly different regulatory requirements across each jurisdiction present additional challenges, as each jurisdiction may (or may not) allow cross-state and/or jurisdictional uses and has different management/accounting rules to accommodate such allowed uses, and may treat aspects such as loyalty points differently (e.g., some jurisdictions may treat loyalty points as currency). Additionally, there are a host of technical, security, and privacy issues, as well as other business-centric concerns that come along with any such linking between a variety of different casino properties. Some of the technical issues include ensuring secure financial transactions (e.g., encryption, authentication, monitoring, and auditing) and adequate data synchronization to ensure the progressive bonus amount and any awarded/winning tickets that may be displayed within the digital wallet stay synchronized (e.g., with low/no latency), which is particularly complex when dealing with high volumes of data associated with wide area progressives.

Having a single system that communicates with and links the different casino systems together to create a progressive bonus system is not possible without some type of unification of the different systems. For example, if the bonus is funded based on funds transactions, a wide area progressive would not be possible, given that such funding/transaction data is stored locally at each casino, without any mechanism in place to share such sensitive information. Thus, in order to arrive at a unitary source such as a single digital wallet that can provide a player with access to all necessary and/or desired information, while also incentivizing usage of the digital wallet via an in-wallet progressive, there needs to be mechanisms that provide for bridging all gaps between the above-noted differences, including measures that account for differences in funding types, casino operator systems, and jurisdictional requirements, as well as overarching aspects such as the handling of sensitive information and voluminous data.

The systems and methods described herein provide for integrating a wide area progressive bonus system into a digital wallet in a manner that streamlines the front-end presentation of transactional information to players, while also streamlining back-end communications and integrations relative to managing the progressive, providing a more engaging and convenient experience for players and promoting digital wallet adoption (e.g., via incentivized usages).

Casino operators may provide a mobile application (e.g., digital wallet, also referred to herein as a “mobile application” or “mobile app”) that can be installed on a mobile phone of the players for performing transactions related to services, and/or gaming operations at the casinos. The players may earn reward points based on the amount of money spent and/or the type of transactions performed. While the reward points may be redeemed for goods and/or services, a player may also opt in to participate in a progressive bonus award system integrated into the digital wallet application, in which the player may receive or earn one or more tickets for each transaction performed using the mobile application. The tickets may be digital tickets, similar to a raffle ticket of a raffle. A pool of prize money may be initially created by the casino host or an owner of the mobile application (that may be the casino host in some examples) for a specific promotional time period. During the promotional time period, the pool of prize money may progressively increase based on an increase in participation by the players and/or a number of transactions performed by the participant players. At the end of the promotional time period, a winning ticket is randomly drawn, and the player having the matching winning ticket may then be awarded the entire prize money of the pool. As described below, the mobile application, in communication with a progressive server, manages the progressive bonus and communicates when the drawing is happening and how much the award is.

The digital wallet may utilize a wallet service broker that provides virtual fund transfer orchestration. A wallet service broker may be configured to include a transfer orchestrator (described in more detail below) that performs a variety of application programming interface (API) calls to interface and manage a variety of independent systems. The transfer orchestrator, also referred to as a wallet transfer orchestrator, may interface with a master ledger that tracks virtual funds moved between user virtual accounts to venue virtual accounts. In one embodiment, a master ledger account may be managed and stored off-premises and/or externally to the casino venue system. The casino venue system may also include a casino management system (CMS) and other gaming application services. The transfer orchestrator may also manage fund requests and/or instructions originating from a mobile app on a mobile device, and may also be utilized for issuance of tickets. For example, the transfer orchestrator may communicate with a server to trigger the issuance of tickets. After receiving a fund transfer request from the mobile app, the transfer orchestrator may be configured to interface and communicate with a CMS or other venue wallet system to initiate the transfer of virtual funds from the user virtual account to the venue gaming account From the venue wallet, the transfer orchestrator may facilitate the transfer of virtual funds from the venue wallet to the gaming device via a gaming device interface (e.g., NFC and/or Bluetooth connection). For every API call initiated by the transfer orchestrator, the wallet service broker may store each API within a wallet database to detect and resolve failures.

In some embodiments, players at different casino properties may participate in the mobile app progressive bonus award system, and players of a first casino property may win a different number of tickets for the type of transactions and the amounts of money spent than players of a second casino property. In some embodiments, the player may be awarded a number of tickets based upon a player level of the player. By way of a non-limiting example, the player level is assigned to the player based on the player's gaming activities that may include wager amounts and how often the player plays. The player level may be one of a player level from “Maverick”, “Gambler”, and/or “Legend” player levels, for example. Based on the player's active use of the mobile application to perform various transactions during the promotional period, the player may get multiple opportunities to earn tickets.

In some embodiments, and by way of a non-limiting example, participation in the mobile app progressive bonus award system may be limited to players who have enrolled in a loyalty program. Additionally, or alternatively, only transactions performed using the mobile application after the player has provided consent to participate in the mobile app progressive bonus award system may be considered for awarding one or more tickets to the player, as described herein.

In some embodiments, and by way of a non-limiting example, funding of the progressive bonus award system may occur in many different ways. For example, an owner of the mobile application may provide initial or seed capital in a preset amount, and one or more casino hosts may match the initial or seed capital. By way of a non-limiting example, matching the initial or seed capital may be for each property at which transactions performed by participating players may qualify them to receive one or more tickets. The initial or seed capital provided by the owner of the mobile application may be between a predetermined minimum value and a predetermined maximum value.

Additionally, or alternatively, during the promotional time period, the owner of the mobile application and/or the one or more casino hosts may add additional funds to increase the award value to be awarded to a player who owns the winning ticket. In some embodiments, the additional funds added to the pool of the prize money may be predetermined and may be added one or more times until the prize money is awarded to a player who owns the winning ticket. By way of a non-limiting example, a source of the additional funds and/or the initial capital may include a portion of digital transaction fee wallet transaction fee, retail transaction fee, hotel transaction fee, and/or race and sports transaction fee. Additionally, or alternatively, the source of the additional funds and/or the initial capital may include some percentage of the bets wagered by players at one or more EGMs, one or more slot tables, and so on. The amount of the progressive bonus award may change over time, and it is shown in a noticeable manner within the mobile app as the amount changes.

Additionally, or alternatively, the progressive bonus prize money and/or the additional funds being added to the award value may have an upper limit and may not exceed the specific predetermined upper limit value. The additional funds may be added to the progressive award value each time when a new player or a certain number of new players decide to participate in the progressive bonus award system. In other words, when a certain number of players at one casino property enters the progressive bonus award system through the mobile app, or a certain number of players across all participating casino properties joins to participate in the progressive bonus award system, the additional funds may be added to the progressive award value. In some embodiments, and by way of a non-limiting example, the participating players may be notified, for example, through the mobile application, that additional funds will be added when a particular number of new players joins the mobile app progressive bonus award system.

In some embodiments, the additional funds being added to the progressive award value may not be a fixed amount. Instead, the first time the additional funds are added may be a predetermined fixed value (e.g., $2,500), and subsequent additional fund values may be doubled (e.g., $5,000, $10,000, $20,000, and so on). Instead of the subsequent additional fund values being doubled, the subsequent additional fund values may be tripled, or any (or no) other multiplier value may be used. For example, an entity that establishes the progressive bonus may fund a minimum value of the progressive bonus and then increase the value by a preset amount, after each of one or more minimum participation quantities is/are reached (e.g., a total pool across all casinos properties participating in the progressive, or by an individual casino property). In such a configuration of the progressive bonus, a minimum participation quantity may need to be met before the bonus is active and able to be won (e.g., a reserve quantity, such as 100 tickets). In one embodiment, after the minimum reserve quantity is met, the establishing entity may open funds of a starter amount (e.g., $1,000) to be won. Once the quantity of tickets reaches 1,000 tickets, another amount (e.g., $1,000) may be added to the progressive bonus. This may occur up to a certain total amount (e.g., $10,000). In another embodiment, there may be a certain quantity of set levels for the progressive bonus amounts, such as three levels. A starting value added after the minimum reserve quantity is met may be a first amount such as $2,500 (e.g., a first level). Once participant entries (e.g., in total) reach 10,000, the amount may be doubled to a second amount such as $5,000 for the progressive bonus (e.g., a second level). Further, once an additional 20,000 participant entries are earned in the promotional period, the bonus amount may double again to a third amount such as $10,000 (e.g., a third level). The amounts and thresholds described above are merely examples and may vary based on business metrics of the establishing entity and/or other factors.

In some embodiments, the players participating in the mobile app progressive bonus award system may contribute to the pool of prize money and may receive one or more tickets. For example, the player may receive 10 tickets for a contribution of $100 to the pool of prize money. In some embodiments, the additional funds may include a matching contribution amount for the contribution made by the players. In some embodiments, the additional funds may include the matching contribution amount if other conditions, such as specific number of transactions are performed by the player and/or the mobile application usage for a specific number of days, in addition to contribution by the player. In some embodiments, a portion of the matching contribution may be used as seed capital for the next progressive bonus award.

In some embodiments, the ticket issued to the player may be automatically generated using a random number generator (RNG) associated with the mobile app and/or in conjunction with a related server including but not limited to a progressive server in communication therewith. A winning ticket number may be generated or selected using an RNG. Accordingly, if no player owns a ticket with a winning ticket number, the progressive award value may keep on increasing until the next winning ticket number is drawn. By way of a non-limiting example, a number of times the progressive bonus award will hit (or in other words the winning ticket number is issued to a player), and a particular level of the progressive may be randomly selected using an RNG. In other embodiments, the winning ticket number is selected from the pool of all issued ticket numbers. In this case, a winner will be selected each time a drawing is made, and at least a portion of the progressive bonus amount will be awarded.

In some embodiments, minimum participation may be required before the pool of progressive prize money may be activated for awarding to a player owning the winning ticket. By way of a non-limiting example, the minimum participation may be a particular number of players participating in the progressive bonus award system, and/or distribution of a particular number of tickets to players participating in the progressive bonus award system.

It is described herein that one player who has been assigned the winning ticket may win the entire progressive pool award value. However, when players across more than one casino properties are enrolled in the progressive bonus award system, it is possible that only the one player who owns the winning ticket may win the entire progressive pool award value, less a predesignated amount that may be awarded to other players such as a player who has earned the highest number of tickets for a casino property being given a fixed amount of prize (e.g., $250).

The players may receive tickets for qualifying transactions during one or more sessions of a promotional period. By way of a non-limiting example, each session of a promotional period may be of a fixed number of days or a different number of days (e.g., 3 days to 30 days). The player may view a number of tickets earned during each session of the promotional period and corresponding transactions using the mobile application. Additionally, or alternatively, the player may view a current value of the progressive prize value that will be awarded to a winning ticket owner, and/or details of a winning ticket on the mobile application.

In some embodiments, the players may earn tickets for performing transactions using the mobile application. The transactions may include, but are not limited to, (i) sign up for the digital wallet; (ii) make a first deposit; (iii) transfer money; (iv) use the “share with friend” feature; and/or (v) provide feedback on the features of the mobile application and/or services at one or more participating casino properties, and so on. Additionally, or alternatively, a player may receive one or more tickets as bonus tickets based on their usage of the mobile application (e.g., daily usage of the mobile application, and/or weekly usage of the mobile application). One or more tickets as bonus tickets may also be awarded to a player for the player exploring a specific feature of the mobile application. By way of a non-limiting example, the specific feature of the mobile application may be a mobile game (e.g., daily wheel). Thus, if a player plays a mobile game via the mobile application, that player may be awarded one or more bonus tickets that may be eligible to win the progressive prize value.

In some embodiments, a player may receive additional or bonus tickets if the player is an employee (or a member of group) that promotes, engages, and/or enrolls other players to use the mobile application and participate in the progressive bonus award system. Additionally, or alternatively, a number of additional or bonus tickets awarded to the employee player may depend on a number of other players who join and participate in the progressive bonus award system.

In some embodiments, and by way of a non-limiting example, a total number of tickets a player may earn in general, and/or for a specific transaction type, may be limited to a predetermined number of tickets. In one example, a player may earn a maximum of 100 tickets for a particular progressive award drawing. In another example, a player may earn a maximum of 10 tickets for each transaction performed or initiated within the mobile application (or the digital wallet app).

In some embodiments, a specific casino property may be promoted over other casino properties, and the mobile application may be promoted over other mobile applications available for similar purposes such as a digital wallet and/or an online payment, and so on. Various metrics may be generated for identifying, for example, features that are more popular among players, a particular time when the most transactions are performed by the participating players, and/or a total number of players per each participating casino property, and so on. In some embodiments, different casino brands may collaborate together to make a single progressive bonus award system available to their guests or players.

The progressive bonus award system, as described herein, may be setup or configured by a casino operator (or an agent for the casino) using a web-based application (e.g., a secure web-based application). The casino operator (or the agent of the casino) may be granted permissions to configure the progressive bonus award system, view the progressive bonus award system configuration, draw a winning ticket number, and/or edit the progressive bonus award configuration.

In some embodiments, the casino operator (or an agent for the casino) may configure the system for awarding tickets to players, for examples, based on (i) digital wallet transactions; (ii) an amount of funding or contributions from the player to the progressive bonus award system; (iii) a number of transactions performed by the player; (iv) usage of the mobile application; (v) badges earned as a user of the mobile applications, and/or (vi) a bonus award. Additionally, or alternatively, the casino operator may also configure a limit on the number of tickets that the player can earn per day and/or for the promotional time period of the progressive bonus award.

In some embodiments, the casino operator may also configure how the progressive bonus award system will be funded. For example, the casino operator may configure a percentage of contribution for different transaction types for transactions performed at one or more participating casino properties. Additionally, or alternatively, the casino operator may configure types of transactions for which the player may earn tickets. By way of a non-limiting example, the types of transactions may include, but are not limited to, (i) slot machine transactions; (ii) poker table transactions; (iii) hotel transactions; (iv) retail transactions; and/or (v) race and/or sports transactions. The casino operator may configure the system to limit or restrict players of certain rating types and/or levels from participating in the mobile app progressive bonus award system. The casino operator may configure the system to identify transactions related to certain games and then excluded those transactions for awarding tickets to the player.

In some embodiments, the mobile app progressive bonus award system may be activated only for transactions performed in specific zones of the participating casino property. In some embodiments, the progressive bonus award system may be activated only for transactions performed at certain EGMs (e.g., new EGMs or EGMs with new games).

In some embodiments, the casino operator may setup a minimum contribution amount for the player to join the mobile app progressive bonus award system, and/or to earn additional or bonus tickets. In some embodiments, the player may be awarded additional or bonus tickets for the transactions performed by the player as configured by the casino operator.

In some embodiments, the progressive bonus award system may be configured as a multi-tier progressive bonus award system. Each tier or level of the multi-tier progressive bonus award may increase the award value. Each tier or level of the multi-tier progressive bonus award may be active for a configurable duration, such as, a day, a week, and/or a month.

As described herein, while a single player owning the winning ticket number receives the entire award money, players earning maximum number of tickets at each casino property may be awarded meta-awards (e.g., different badge levels) as configured by the casino operator. The players may receive additional or bonus tickets, based on their earned badge levels, for the next round of progressive bonus award system.

In some embodiments, the casino operator may also configure that the players may view a current Jackpot amount of the progressive bonus award in the mobile application view on their mobile device. The casino operation may enable pushing a notification on each participating plyer's mobile device, or on the mobile device of the player having the winning ticket, of the winning ticket number and/or the amount of award. Additionally, or alternatively, the notification may be sent to each participating plyer's mobile device, or a selected group of participating plyers' mobile device, for promotion of the progressive bonus award system.

In some embodiments, various reports including, but not limited to, audit reports, winner reports, transaction reporting for the transactions performed by the participating players, and/or contribution or funding reports may be generated for review/use by the various casino and/or other applicable entities described herein. The reports may include the winning ticket number and/or date and time when the winning ticket number is drawn.

In some embodiments the systems described herein may further include a system that includes an off-premises, global player management system that may capture user data across multiple venues. With this system, the venues do not need to belong to the same enterprise and, in fact, can be associated with different enterprises (e.g., venues associated with different operators).

In these exemplary embodiments, the system may include a global player management services system to capture user data over multiple venues. The global player management services may map a single player database record to multiple venue database records. By doing so, the global player management services can generate session summary information for a single user over multiple venues to determine whether a user has breached responsible gaming limits. As an example, the responsible gaming limits may be user-defined responsible gaming limits (e.g., amount spent or length of play). To map a single player database record to multiple venues, the global player management services may link a user's top-level virtual account stored in the system primary account to different player loyalty identifiers/account across multiple venues. The global player management services can be configured to have a single player database record within a certain country or other jurisdictional boundaries.

While architecture of the progressive bonus award system may include an application server (e.g., an application server in cloud computing network) interfaced with other components to perform various transactions described herein, and the participating players may view the current award value using the mobile application, display devices may be placed at or near various gaming machines displaying the current award value.

In one exemplary embodiment, the progressive bonus award rules and configurations described herein may be stored in one or more server-side components of the mobile application, one or more client-side components of the mobile application, the ledger, or a gaming point-of-sale backend.

In other embodiments, progressive bonus award rules and configurations may be stored in a standalone manner as a centralized progressive bonus rule tables in a (e.g., centralized) database of the progressive bonus system in a computing cloud. The centralized database, for example, allows the progressive bonus system to look up the rule tables to determine a player's eligibility based on the location of the player (e.g., at a casino venue, online gaming session at home, a sports stadium, etc.), the player's status level (e.g., “Platinum”, “Diamond”, “Gold”, “Silver”, etc.), the eligibility of the game type (e.g., table, slot, sports, etc.), the size of the wager (e.g., $2 or more per bet), length of the game session (e.g., at least 15 minutes), etc. Similarly, the award size and type (e.g., number of points and/or progressive ticket entries awarded for each eligible gaming activity) may be configured to be based on the transaction type, location, time, marketing campaign operating parameters, and the like. The centralized database, progressive bonus systems, ledger (e.g., centralized accounting ledger), and rule tables allow multiple gaming venues (including online gaming venue) to be interconnected in a network of cross-venue, multi-session, multi-player, multi-tier progressive (e.g., progressives with multiple award tiers) award transactions database system. While such a multi-site progressive may be provisioned across multiple venues, physical or online, custom progressives may also be designed to conform/adhere to a local venue's requirements. For example, a venue could have both a common wide-area progressive sharing with other venues, and a custom local progressive at the same time.

In some embodiments with a centralized progressive bonus system, a user/player at a physical casino venue and a user/player at an online venue may be awarded differently for their transactions. In general, any venue at any location may have its own special rule set. A custom configuration of the progressive bonus award may be preset and used in determining the number of tickets and/or points rewarded depending on the venue (whether physical or online), the zone where the user/player is at that within that venue (e.g., zone-based awards), the classification of the user/player, the promotional campaign at that venue at that particular time (e.g., 3:00 p.m. on a Tuesday), jurisdictional requirements (e.g., state-specific jurisdictional requirements, such as not permitting a lottery), etc.

In some embodiments, a user/player is allowed to exchange their loyalty points for the progressive bonus tickets. For such a situation, a points conversion table is also stored (and centrally updated for each promotional event as needed) at the centralized database system. Similar to the rules governing the progressive bonus system, the conversion table may also be based on the venue where the user/player is at, the zone/location where the user/player is at within that venue (e.g., location-based awards), the player classification of the user/player, the promotional campaign at that venue at that particular time, local jurisdictional rules regarding points conversion (loyalty points may be considered to be a currency at some jurisdictions instead of a non-currency compensation, and that could affect tax withholding, for example), and the like.

Loyalty points exchange to progressive entry tickets provides exchange rate flexibility. The exchange rate avoids the issue of fractional tickets, variations in jackpot contribution at each gaming venue, and allows additional flexibility for each individual gaming venue to set the exchange rate as a function of the transactions at their own facilities, gaming or non-gaming. Additionally, the loyal points exchange system allows players to accumulate loyalty points and choose an opportunistic time (e.g., when a Jackpot passes $1,000,000 dollars) to exchange for the ticket entries for the progressive bonus.

When player loyalty points and/or other promotional points are being used for exchanging into an entry ticket for a wide-area (multi-site) progressive, a conversion process is needed. The process can be more involved since each gaming venue (online or land-based) have different loyalty programs that distribute points for different user activities (e.g., different quantity of points for gaming devices, hotel room rented, meals, shows, etc.).

On top of the venue loyalty points, a player may also receive points from third-party sponsors such as manufacturers of slot machines, digital payment processing companies, food and drink providers, luxury goods stores, etc. These various points may have different values, causing different exchange rates to convert them into universal points that can be used to buy entries into the wide-area progressive. For example, at venue A, 1 point is awarded for every $1 spent on wagering activities, while 0.5 points is awarded for all other transactions at the gaming venue. At venue B, 1 point is awarded for every $1 in transaction, regardless of venue activities. An independent third-party such as a slot machine manufacturer may provide 3 points for every $1 of play on any of their slot machines during a particular timeframe such as the month of December, and 1.5 points for each $1 wagered on their machines any other time, etc.

In some embodiments, when a user choses to redeem points for ticket entries into the progressive drawing, all the points from all the venues that the user is associated with are aggregated. This process may require a centralized mediation system to unify incompatible loyalty point systems from each independent venue.

Having a centralized progressive with universal point conversion system allows for normalization of the points variations, regardless of how the original point systems were structured for the users, how a user earned the points at each venue they visited, and the transactions they made while at that venue.

The conversion process begins with a user making a request to the centralized progressive server to exchange his or her points from their accounts for entries to the multi-site progressive. This means that either the user has registered all the venues that the user has their player account at, or that the central progressive system polls every venue and system connected to it to find out if a user has an account there, and if so, what their balances are. A user may select the option that is more convenient for them.

The centralized server then: (i) looks up relevant venues connected to the wide-area progressive network; (ii) connects to the venues that positively confirmed a player's account, requesting from each of these venues to send the points associated with the player ID according to the player's request; (iii) aggregates the points from the one or more venues; and (iv) looks up the central system's conversion tables for the conversion factors to convert each type of points from each venue to the universal points. After the conversion, these points are aggregated and used to exchange for one or more entry tickets to the progressive(s) according to the universal points exchange rate.

The complexity of the exchange process may require a system that can mediate between all connected venues and their customized programs to get one or more entries into the centralized progressive. This process may involve communications from a central system to other (potentially incompatible) systems from various venues through custom API's and then perform the intricate mediation process to convert the incompatibilities between the loyalty systems and their custom configurations for loyalty points compensation as a function of transactions to arrive at a user's available universal points. Once complete, the exchange process for the progressive entries can be made. Finally, all the remote points systems where the points were drawn from need to be updated, via their corresponding APIs, for the points that were used in the exchange process, allowing the local systems to reconcile and update their point balances of the user account at that venue that requested the progressive entry exchange.

In some embodiments, a player's award may depend on the game itself. For example, table games may receive a different award compensation (points and/or tickets) from slot games, from sports betting, and the like. For instance, the award compensation table might have different event triggers, awarding different values at different times and perhaps different locations. A centralized rules system allows flexibility for a real time update of changes as well as broadcasting the updated rule tables to the various local progressive and bonus systems connected to the central server.

Progressive systems often have many meters and controlling data to record the relevant progressive data as well as for reporting the data to the jurisdictional government agencies. Since a multi-venue progressive bonus system may encompass approval and reporting for multiple states, the progressive meters and progressive data reporting also needs to conform to the local jurisdictional requirements (e.g., each local jurisdiction may require something different). Examples of progressive meters include data such as money in, progressive size, seed amounts, payouts, location ID, etc., while examples of progressive data can include location and time of each transaction, eligible games, eligible players, eligible locations, expected payout amount, actual payout amount, expected time between payouts, deviations, progressive contribution from each transaction for each game, aggregate contribution from each venue, and the like. The progressive bonus system report would include all the progressive meters and operating data required by all the local jurisdictions, and the ability to customize the periodic performance report generation for each local jurisdiction according to its requirements.

The technical problems addressed herein include: (i) fragmented, proprietary, and incompatible digital wallets in the casino industry; (ii) lack of incentivizing players to use digital wallets in the casino industry; (iii) inability of known digital wallets to integrate with multiple different casino systems; (iv) properly and efficiently handling and processing voluminous amounts of data, including sensitive data; and/or (v) lack of facilitating game play on EGMs or other gaming devices via a mobile application.

The system described herein may provide one or more of the following technical effects and/or technical benefits: (1) reducing a number of data transfer operations and overall computational bandwidth needed to implement a digital wallet system by reducing a number of actual funds transfers needed to implement the digital wallet system by using a ledger to record at least some of the transactions as virtual funds transfers within the ledger rather than an actual funds transfer between separate external accounts; (2) improving computing efficiency of a computer system that provides a digital wallet system by reducing a number of actual funds transfers needed to implement the digital wallet system by using a ledger to record at least some of the transactions as virtual funds transfers within the ledger rather than an actual funds transfer between separate external accounts; (3) enabling presentation of multiple virtual wallet accounts of a user associated with separate venues as a single virtual wallet account associated with the user by providing an orchestrator that immutably records virtual funds transfers between one or more virtual accounts associated with the user and virtual accounts associated with the venues in a ledger; (4) providing a system that integrates separate and independent CMSs and associated payment systems by recording gaming transactions within a ledger and transferring funds between venue gaming accounts and a system account based on records stored in the ledger; and/or (5) providing additional information and digital wallet and progressive gameplay features to a user (e.g., player) of the mobile application within a limited amount of display space via an enhanced graphical user interface (GUI) of the mobile application, including providing, via the GUI, additional information to the user during use of the mobile application to apprise the user of the status of their account and their entries in the progressive and any winnings.

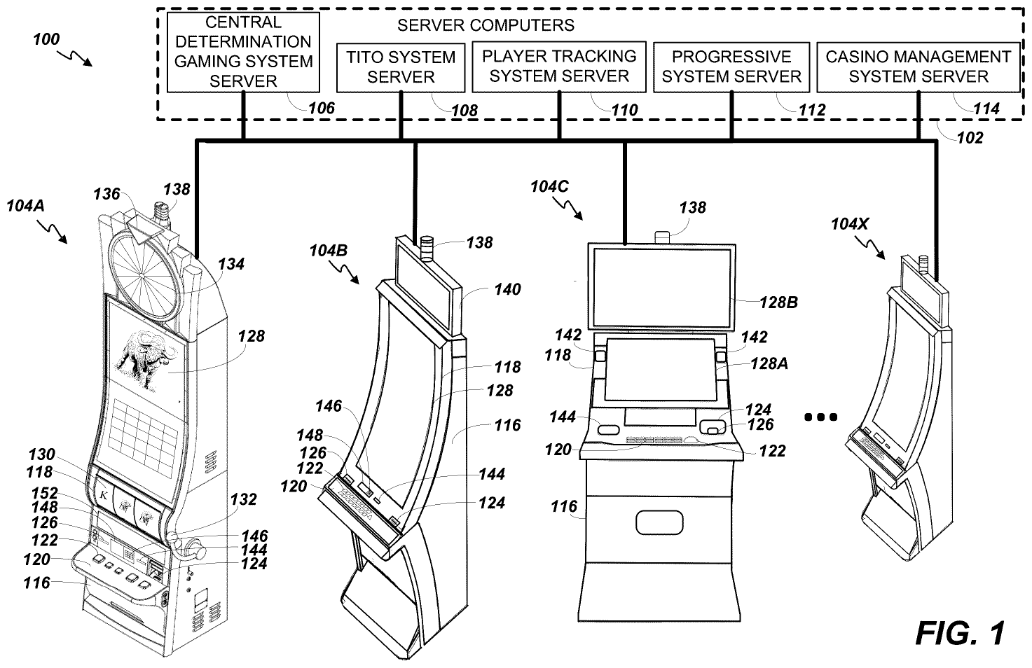

Various exemplary embodiments described herein are discussed below in more detail with respect to FIGS. 1, 2A, 2B, 3, 4A to 4E, 5A to 5C, 6-8, 9A to 9F, and 10-12.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Realm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

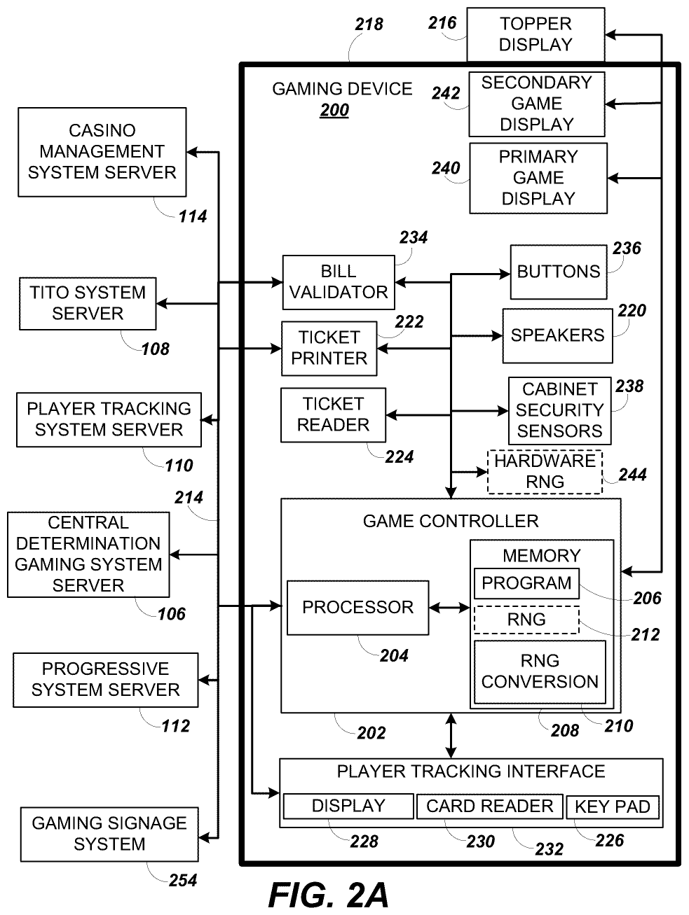

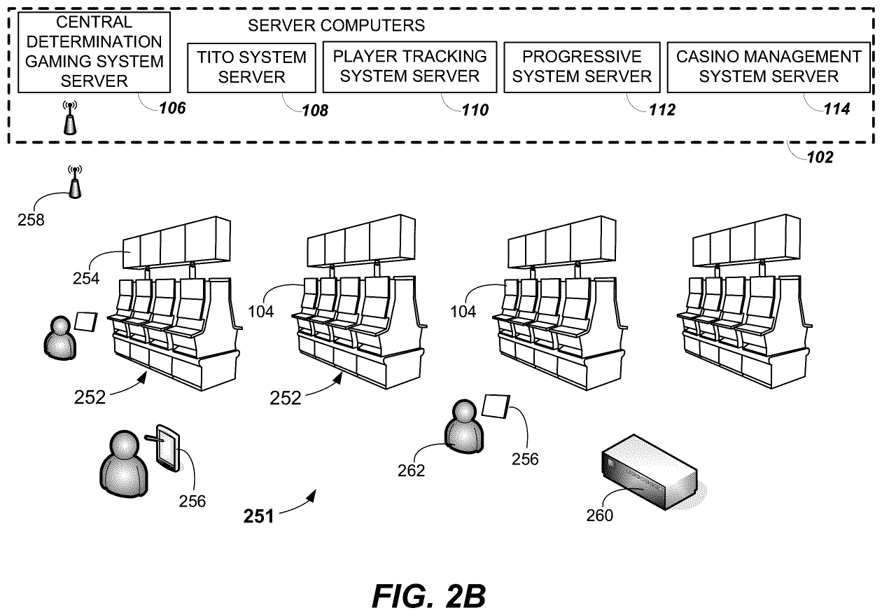

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

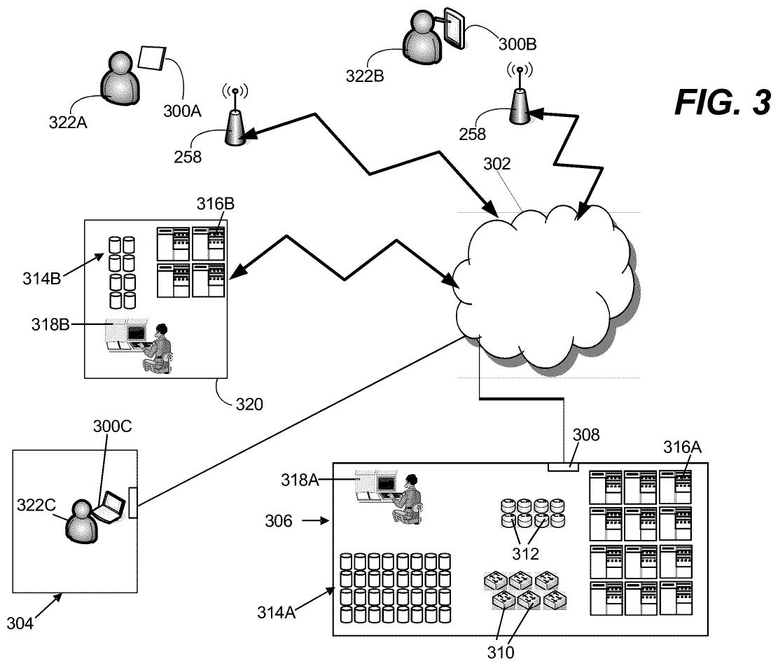

FIG. 3 is a diagram that shows examples of components of a system for providing online gaming according to some aspects of the present disclosure. As with other figures presented in this disclosure, the numbers, types, and arrangements of gaming devices shown in FIG. 3 are merely shown by way of example. In this example, various gaming devices, including but not limited to end user devices (EUDs) 300A, 300B and 300C are capable of communication via one or more networks 302. The networks 302 may, for example, include one or more cellular telephone networks, the Internet, etc. In this example, the EUDs 300A and 300B are mobile devices: according to this example the EUD 300A is a tablet device and the EUD 300B is a smart phone. In this implementation, the EUD 300C is a laptop computer that is located within a residence 304 at the time depicted in FIG. 3. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 306 includes various devices that are configured to provide online wagering games via the networks 302. The gaming data center 306 is capable of communication with the networks 302 via the gateway 308. In this example, switches 310 and routers 312 are configured to provide network connectivity for devices of the gaming data center 306, including storage devices 314A, servers 316A and one or more workstations 318A. The servers 316A may, for example, be configured to provide access to a library of games for online game play. In some examples, code for executing at least some of the games may initially be stored on one or more of the storage devices 314A. The code may be subsequently loaded onto a server 316A after selection by a player via an EUD and communication of that selection from the EUD via the networks 302. The server 316A onto which code for the selected game has been loaded may provide the game according to selections made by a player and indicated via the player's EUD. In other examples, code for executing at least some of the games may initially be stored on one or more of the servers 316A. Although only one gaming data center 306 is shown in FIG. 3, some implementations may include multiple gaming data centers 306.

In this example, a financial institution data center 320 is also configured for communication via the networks 302. Here, the financial institution data center 320 includes storage devices 314B, servers 316B, and one or more workstations 318B. According to this example, the financial institution data center 320 is configured to maintain financial accounts, such as checking accounts, savings accounts, loan accounts, etc. In some implementations one or more of the authorized users 322A, 322B, and 322C may maintain at least one financial account with the financial institution that is serviced via the financial institution data center 320.

According to some implementations, the gaming data center 306 may be configured to provide online wagering games in which money may be won or lost. According to some such implementations, one or more of the servers 316A may be configured to monitor player credit balances, which may be expressed in game credits, in currency units, or in any other appropriate manner. In some implementations, the server(s) 316A may be configured to obtain financial credits from and/or provide financial credits to one or more financial institutions, according to a player's “cash in” selections, wagering game results and a player's “cash out” instructions. According to some such implementations, the server(s) 316A may be configured to electronically credit or debit the account of a player that is maintained by a financial institution, e.g., an account that is maintained via the financial institution data center 320. The server(s) 316A may, in some examples, be configured to maintain an audit record of such transactions.

In some alternative implementations, the gaming data center 306 may be configured to provide online wagering games for which credits may not be exchanged for cash or the equivalent. In some such examples, players may purchase game credits for online game play, but may not “cash out” for monetary credit after a gaming session. Moreover, although the financial institution data center 320 and the gaming data center 306 include their own servers and storage devices in this example, in some examples the financial institution data center 320 and/or the gaming data center 306 may use offsite “cloud-based” servers and/or storage devices. In some alternative examples, the financial institution data center 320 and/or the gaming data center 306 may rely entirely on cloud-based servers.

One or more types of devices in the gaming data center 306 (or elsewhere) may be capable of executing middleware, e.g., for data management and/or device communication. Authentication information, player tracking information, etc., including but not limited to information obtained by EUDs 300A-300C and/or other information regarding authorized users of EUDs 300A-300C (including but not limited to the authorized users 322A-322C), may be stored on storage devices 314A, 314B and/or servers 316A, 316B. Other game-related information and/or software, such as information and/or software relating to leaderboards, players currently playing a game, game themes, game-related promotions, game competitions, etc., also may be stored on storage devices 314A, 314B and/or servers 316A, 316B. In some implementations, some such game-related software may be available as “apps” and may be downloadable (e.g., from the gaming data center 306) by authorized users.

In some examples, authorized users and/or entities (such as representatives of gaming regulatory authorities) may obtain gaming-related information via the gaming data center 306. One or more other devices (such EUDs 300A-300C or devices of the gaming data center 306) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

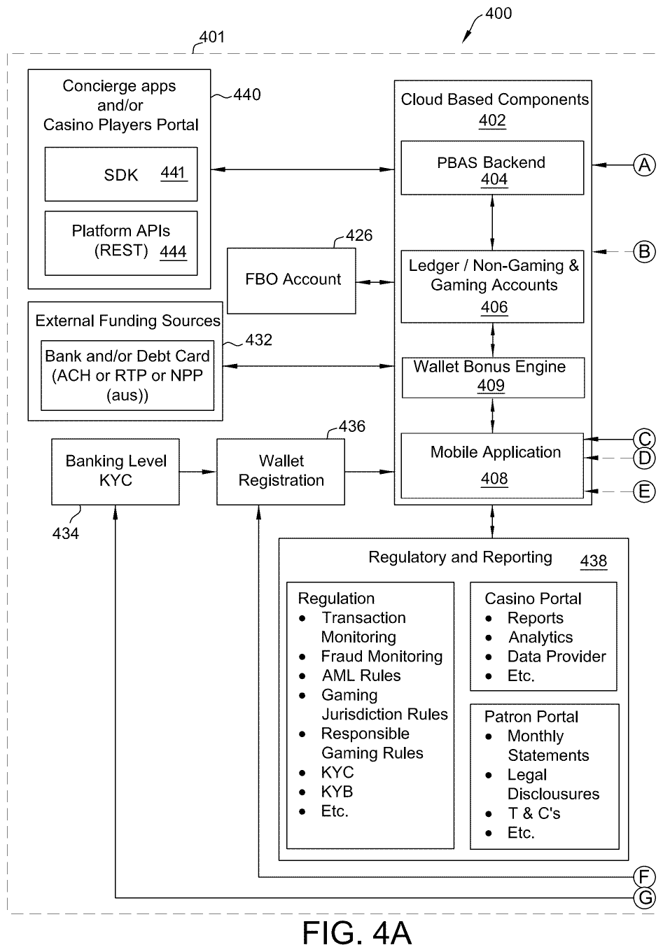

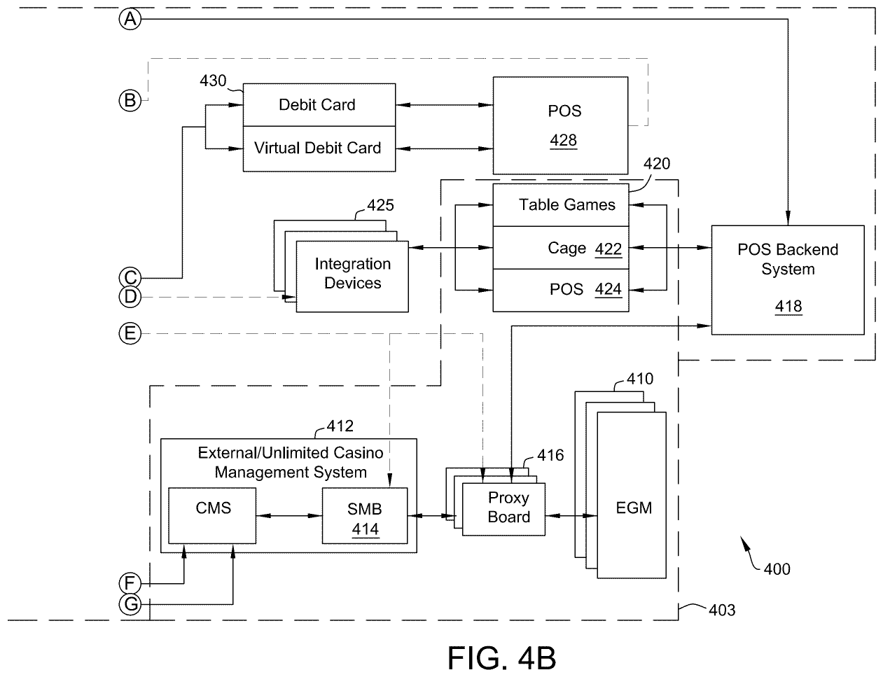

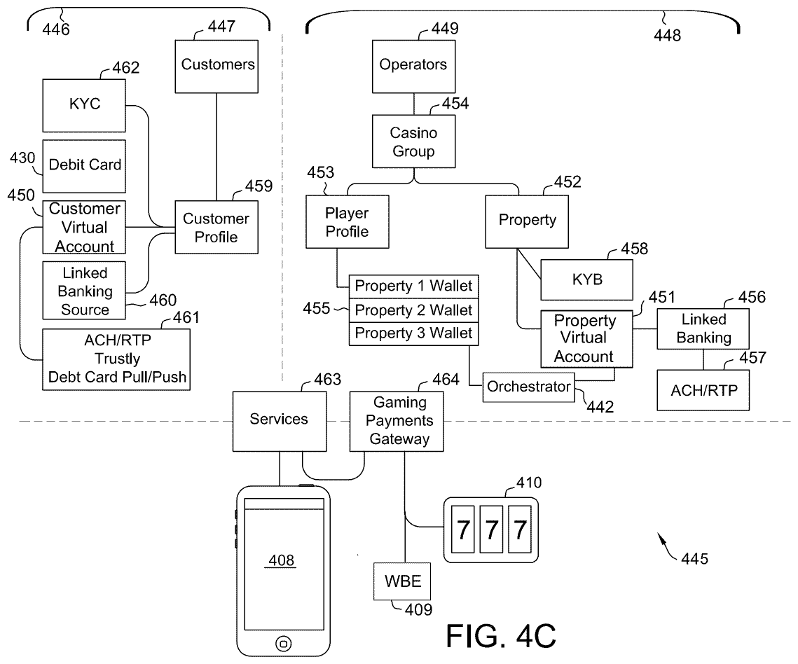

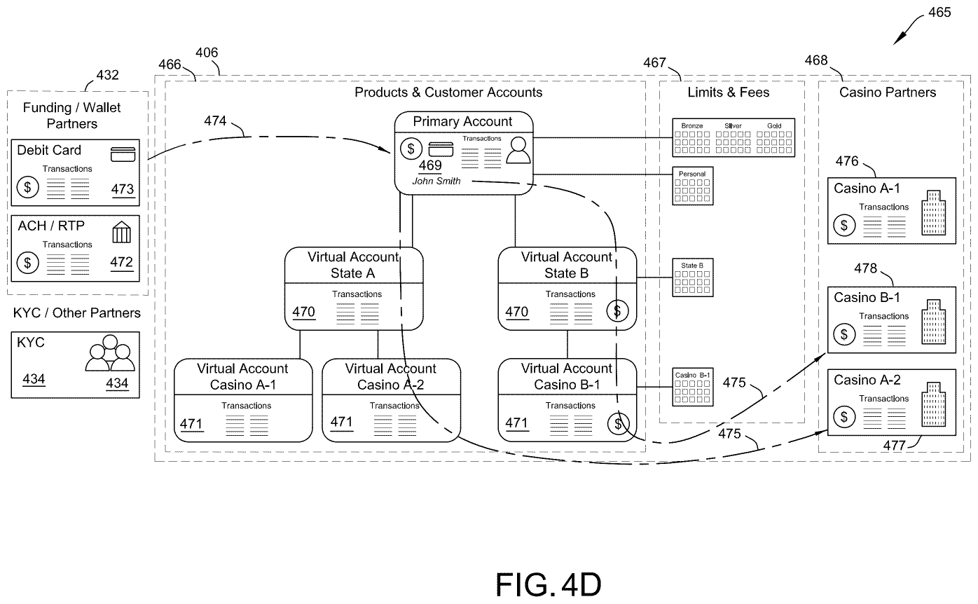

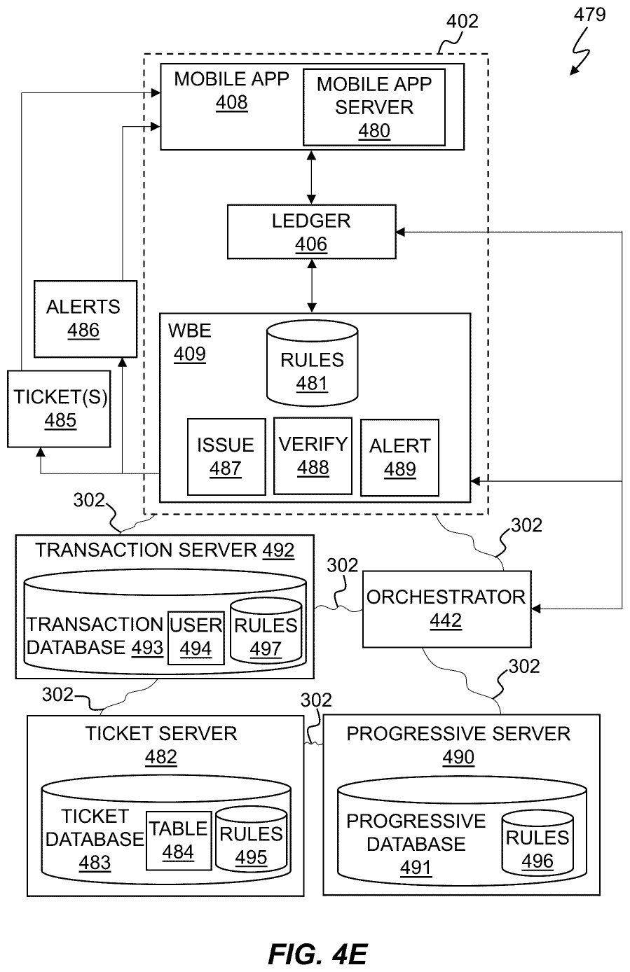

FIGS. 4A and 4B illustrate an overview of some of the components and services of a mobile app progressive bonus award system (PBAS) 400 of a universal wallet system (UWS) 401 according to an example embodiment. Any of the components of the mobile app PBAS 400 may be performed, for example, by server computers 102 of FIG. 1. In the example embodiment, the mobile app PBAS 400 includes cloud-based components 402 (which may also be referred to as a remote computing system), which may include one or more processors and/or memory devices configured to execute and/or provide a gaming system 403, a gaming point of sale (POS) backend 404, a ledger 406, a mobile application 408, and/or a wallet bonus engine (WBE) 409, each of which are described in further detail below. The gaming POS backend 404 may be also referenced herein as the mobile app PBAS backend 404. Ledger 406 may be a digital ledger configured, for example, as a computer file that stores financial data including but limited to transaction data (e.g., transactions made by players). Ledger 406 may store a plurality of information including transaction data and data of the player that made the transaction. This various data may be used as part of the ticket issuance process as described in more detail herein. The data stored in ledger 406 may be stored in chronological order. WBE 409 may be dedicated hardware and/or software for carrying out certain functions of PBAS 400 directed to the issuance and management of tickets awarded to players, and may be in communication with and/or integrated with a variety of other system components including various servers and databases to carry out such functions.

In the example embodiment, the mobile app PBAS 400 may further include at least one EGM 410, which may be similar to gaming devices 104A-104X described above with respect to FIG. 1. EGM 410 may be configured to communicate with a casino management system (CMS) 412 via a slot machine interface board (SMIB) 414. EGM 410 and SMIB 414 may communicate using Serial Attached Small Computer System Interface (SAS), Serial Advanced Technology Attachment (SATA), or another communication format. In the example embodiment, a proxy board 416 may be coupled between EGM 410 and SMIB 414 and may be configured to communicate with the mobile app PBAS backend 404, in some embodiments, via one or more on-premises components 418 (also referred to herein as POS backend system 418) of PBAS backend 404. Proxy board 416 may be “invisible” to EGM 410 and/or SMIB 414, in that proxy board 416 may be configured to transmit signals to EGM 410 that EGM 410 would expect to receive from SMIB 414 and transmit signals to SMIB 414 that SMIB 414 would expect to receive from EGM 410. Thus, proxy board 416 may be installed in an existing casino environment without affecting operation or requiring reconfiguration of EGM 410, CMS 412, and/or SMIB 414. Further, proxy board 416 enables the remainder of mobile app PBAS 400 to be CMS-agnostic, in that the mobile app PBAS 400 does not require CMS 412 to be of a specific design, model, and/or manufacturer. In some embodiments, proxy board 416 may utilize Bluetooth, near field communication (NFC), cameras, quick response (QR) codes, bar codes, data entry forms, or other forms of communication to EGM 410 to communicate with or otherwise link transactions with a user device executing mobile application 408. Transaction communications between on-premises components 418 and cloud-based components 402 may relate to on-site closed loop transactions.

In some embodiments, a registration such as a players club registration via CMS 412 may be used to register the player as a participating player in the progressive bonus award. In such embodiments, this registration may be linked to a universal wallet account of a universal wallet system (UWS) associated with the mobile app PBAS 400. A single universal wallet account may be linked to one or more casino organizations, and the player can monitor or review the progressive bonus award for one or more casino organizations participating in the progressive bonus award. A player may be able to see what casinos are linked (e.g., using mobile application 408), and a casino organization may only have access to player information originating from their organization, and not information from other organizations. The player may also see details of the progressive bonus award. There may not be any direct funds moved from the universal wallet account to CMS 412. CMS 412 may provide information gathering and club registration, if applicable, via standard APIs.

In the example embodiment, the mobile app PBAS 400 may further include on-premises components 418 for gaming POS backend and/or device management. The mobile app PBAS 400 may further include table games 420 (e.g., smart table games), cages 422 (e.g., points at which tickets or vouchers may be exchanged for cash), and/or on-premises POSs 424 (e.g., POS devices associated with stores, restaurants, hotels, and/or other merchants within the casino environment), any of which may be configured to communicate with PBAS backend 404, for example, via on-premises components 418. The mobile app PBAS 400 may further include one or more integration devices 425, through which table games 420, cages 422, and/or on-premises POSs 424 may be further configured to communicate with cloud-based components 402 using mobile application 408. For example, integration devices 425 may utilize Bluetooth, NFC, cameras, QR codes, bar codes, data entry forms, or other forms of communication to enable table games 420, cages 422, and/or on-premises POSs 424 to communicate with or otherwise link transactions with a user device executing mobile application 408.

A player may use mobile application 408 to fund a “for benefit of” (FBO) account 426 (sometimes referred to herein as a “progressive bonus award” (PBO) account) or some other custodial financial account that stores actual funds on behalf of a user or users and/or an entity or entities. The mobile app PBAS backend 404 may track transactions using ledger 406, which may be a centralized and/or intermittent and/or immutable ledger that tracks both gaming transactions across different casino properties and non-gaming transactions for a player's FBO account and/or virtual accounts to determine and award tickets to players participating in the progressive bonus award. In the exemplary embodiment, ledger 406 may be a single master ledger. Ledger 406 may include sub-ledgers (for example, corresponding to each casino property, and/or a zone within any given casino) and all of the sub-ledgers may roll up to the single master ledger 406. FBO account 426 may be a physical account that stores actual funds at a bank. FBO account 426 may be under the name of the entity providing the wide area progressive bonus, for example.

With regards to gaming transactions or other transactions conducted on-site at a casino (e.g., at EGM 410, table games 420, cage 422, and/or on-premises POS 424), by utilizing ledger 406, the mobile app PBAS 400 may track these transactions for determining a number of tickets to be awarded to a player participating in the progressive bonus award.

In some embodiments, to load funds onto EGM 410, and/or to contribute to the progressive bonus award system, the player may send a request using the mobile application 408 to proxy board 416. Proxy board 416 may be configured to forward such requests via on-premises components 418 to PBAS backend 404, which may then lookup information in ledger 406 to perform appropriate actions. Similarly, transactions made at on-premises POS 424 may be completed using PBAS backend 404, and a number of tickets may be determined and assigned to a player corresponding to the transactions. For non-gaming transactions (sometimes referred to herein as “open loop” transactions), for example, at an off-premises POS 428 (e.g., retail POS, Apple Pay, and Google Pay), debit card 430 may be used to conduct transaction. While debit card 430 may be a physical card, it may also include a virtual card version thereof. The mobile app PBAS backend 404 documents such non-gaming transactions on ledger 406 and determines and awards tickets corresponding to the performed transactions.

FBO account 426 may be funded from one or more (e.g., external) funding sources 432, which may be, for example, a linked bank account and/or a linked debit card (e.g., via automated clearing house (ACH), etc.) and may function similarly to PayPal or other similar products, such as other digital wallet products. For example, a player may, using mobile application 408, transfer funds from funding source 432 to FBO account 426, and an updated balance for the player may be recorded in ledger 406. A number of tickets and their ticket numbers may also be updated in the ledger 406. Accordingly, when a winning ticket number is drawn, a player who owns the winning ticket number may be identified and notified. And, if it is determined that the no player owns the winning ticket number, the progressive bonus award may go to the next level, and the award value may also increase during the next level.

Know your customer (KYC) information 434 may be used for wallet registration 436 using mobile application 408, which may result in one or more virtual accounts being generated and recorded for the player in ledger 406. In some embodiments, a KYC call may be performed when the player adds fund as contribution to the progressive bonus award, in which KYC information 434 may be used to determine if player data in the system matches what is returned from other KYC sources (e.g., a casino CMS call if the player is registered with casino player tracking). Wallet registration 436 may include registration (e.g., a players club registration) and various account linking.

In some embodiments, cloud-based components 402 may provide a portal 438 (e.g., a user interface) for displaying information, for example, to regulators, casino operators, and/or patrons/players. For example, the portal may display information relating to or enable an application of transaction monitoring, fraud/anti-money laundering rules, gaming jurisdiction rules, KYC information, know your business (KYB) information, reports, analytics, monthly statements, legal disclosures, terms and conditions, and/or other information. In some such embodiments, portal 438 may be accessible though mobile application 408.

In some embodiments, the mobile app PBAS 400 may include one or more casino apps and/or casino players portals 440, which may include a software development kit (SDK) 441 and/or platform application programming interface (API) 444 that enable a casino operator (or contracted developer) to embed universal wallet functionality (e.g., an ability to load and/or transfer funds) within their branded casino apps and/or casino players portals 440.

FIG. 4C is a block diagram 445 illustrating functional/logical operations of UWS 401 (shown in FIGS. 4A and 4B). In FIG. 4C, section 446 depicts customer-side operations associated with a customer 447 (e.g., a user/player), and section 448 depicts operator-side operations associated with an operator 449 (e.g., an operator of UWS 401 shown in FIGS. 4A and 4B). Customer-side operations 446 has a customer virtual account 450 for customer 447, which may be a virtual user account defined by ledger 406, and operator-side operations 448 has a property (e.g., venue) virtual venue account 451, which may be another virtual account defined by ledger 406, setup for a casino property 452. These virtual accounts may be pseudo-DDAs. When payments are settled (e.g., at the end of a day or other predefined period), funds are transferred between FBO account 426 and external accounts (e.g., property bank account 456, described below) based on values associated with virtual funds transfers recorded in ledger 406.

Operator-side operations 448 may include a player profile 453 for a given casino group 454. Each player profile 453 that is created may be linked to a property wallet 455 at each property 452. Property wallets 455 represent the venue gaming accounts used to fund gaming transactions at respective properties 452. Each property 452 may own and control the venue gaming accounts, which are separate accounts from the customer virtual account 450 and are separate from ledger 406. Property virtual account 451 may be linked to a property bank account 456, and funds may be transferred between property virtual account 451 and property bank account 456 using an electronic payment system 457 (e.g., ACH, real time payment (RTP), and/or another proprietary or public electronic payment system). A know your business (KYB) operation 458 may be used to ensure compliance with anti-money laundering and security requirements. An orchestrator 442 may be used in conjunction with property virtual account 451 and property wallets 455 in connection with managing transactions made by a player at casino properties 452 and/or partners (e.g., restaurants, hotels, retail) affiliated with casino properties 452. Orchestrator 442 may also be referred to as a wallet orchestrator and/or a transfer orchestrator, and may be primarily programmed to function as a transaction orchestrator for managing transactions. For example, orchestrator 442 may perform functions directed to: (i) integration management, including integrating various payment service providers, banks, and other financial entities into a single, unified platform, allowing for seamless transactions across different services; (ii) transaction routing, including intelligently routing transactions for efficiency and optimization for factors such as speed and reliability in processing transactions; and/or (iii) security and compliance, including ensuring that all transactions comply with relevant regulations and standards, and protecting user data and sensitive information such as financial information.

Customer-side operations 446 may include a customer profile 459 for a given customer or user. Customer profile 459 may be linked to customer virtual account 450. Customer virtual account 450 may be linked to a customer bank account 460, and funds may be transferred between customer virtual account 450 and customer bank account 460 using an electronic payment system 461 (e.g., ACH or RTP). In some embodiments, as described with respect to FIG. 4B, debit card 430 may be issued and/or linked to customer virtual account 450 to make on-site or off-site purchases using funds from customer virtual account 450. A KYC operation 462 may be used to ensure compliance with anti-money laundering and security requirements.

A pay services operation 463 and gaming payments gateway 464 may be implemented using, for example, cloud-based components 402 shown in FIG. 4A, to enable customer 447 to use mobile application 408 to initiate a virtual transfer of funds or credits from customer virtual account 450 for use at EGM 410. When these funds or credits are transferred by customer 447 to EGM 410 (e.g., by wagering the funds or credits), these funds or credits may be virtually transferred from customer virtual account 450 to property virtual account 452. The virtual funds may then be transferred to EGM 410 from a cashless payment system associated with operator 449. Gaming payments gateway 464 may provide additional functionality such as, for example, verifying a user exists and/or creating a player account. Gaming payments gateway 464 may be used in conjunction with WBE 409 in connection with ensuring that all usages of mobile application 408 and/or transactions that qualify for the awarding of tickets are captured. For example, a casino operator may set a ticket-awarding incentive that is based on a certain number of fund transfers using the mobile application 408. This may include, for example, issuing a ticket to a user that makes n transfers within a certain timeframe/duration.

FIG. 4D is a block diagram of an exemplary centralized ledger system 465, which may be implemented using ledger 406 and/or external funding source 432 shown in FIG. 4A. Ledger 406 may define and/or record one or more virtual customer accounts 466, limits and fees 467, and/or casino/partner accounts 468.

Customer accounts 466 may include or be associated with one or more primary accounts 469, which are virtual user accounts defined by records stored in ledger 406. Primary account 469 may be associated with a user, and may be linked to one or more virtual user sub-accounts for tracking transactions made by a user associated with primary account 469. For example, in the exemplary embodiment depicted in FIG. 4D, primary account 469 is associated with virtual user sub-accounts 470 corresponding to different jurisdictions (e.g., national or state governments, tribal organizations), which may be further linked to or broken down into virtual user sub-accounts 471 for tracking transactions at different casinos or other partnering organizations. Because each virtual user sub-account 471 is associated with a different jurisdiction and a different casino, different limits and fees 467 may be applied to each virtual user sub-account 471 when transferring funds to or from virtual user sub-account 471. For example, limits and fees 467 may include different tiers of fee plans, user-defined limits associated with a particular user, state or jurisdiction-defined limits corresponding to a particular jurisdiction, and/or casino or operator-defined limits corresponding to a particular operator or casino location. In some embodiments, ledger 406 may include one or more virtual accounts such as virtual accounts 470, 471 to track contributions made to the digital wallet or to progressives associated with only a single property (e.g., a single casino such as Casinos A-1, A-2, and B-1 shown in FIG. 4D) or for certain locations such as certain states (such as State A and State B shown in FIG. 4D). For example, ledger 406 may track what digital wallet bonus a player is qualified for.

Primary account 469 may be an account tracked in ledger 406. No money is stored in primary account 469. When a player transfer funds to a casino, a debit transaction is posted in the player's primary account 469 and a credit transaction is posted for the property's (e.g., casino's) virtual account 451. The inverse occurs when a player moves funds from the casino. At the end of a day, session, or other set duration, a reconciliation process may occur where ledger 406 is compared to the record of CMS 668 that track deposits and withdraws from the casino wagering accounts. The record of CMS 668 may be stored locally at the property (e.g., the casino). If ledger 406 matches the casino records, the payment system then performs a payment settlement that transfers funds from FBO account 426 to the casino's bank account. The payment settlement transaction is recorded in ledger 406 under the casino's primary account (e.g., 456). Primary account 469 tracks and monitors the transactions a player has made throughout the day. If a player transfers virtual funds to an EGM 908, such transactions will show up on primary account 469. No daily payment settlement is needed for the user accounts (e.g., 469, 470, 471) since the funds that back the player's FBO account 426 are already stored in FBO account 426. If a player logged in to see their balances, the information is pulled from ledger 406. When a player decides to transfer funds to an external bank account, the real/actual funds are then moved out from FBO account 426 to the external bank account.

It should be appreciated that the ledger structure of ledger 406 depicted in FIG. 4D is an example ledger structure, and that other ledger structures may be used to implement ledger 406. For example, in some embodiments, virtual sub-accounts 470 corresponding to different jurisdictions may not be included (e.g., in cases in which regulators do not need to track this information).

A customer may transfer actual funds to a casino using external funding sources 432, such as an electronic payment 472 (e.g., ACH or RTP) and/or via a debit card 473 (which may be different or the same as debit card 430 shown in FIG. 4C), which may result in ledger 406 being updated to reflect the transfer being added to the balance of one or more virtual user accounts 470 associated with the user. Arrow 474 represents that debit and/or credit transactions from external funding sources 432 may post to primary account 469. Certain situations may result in a virtual transfer of funds between virtual user sub-accounts 471. For example, if the customer attempts to load credits onto an EGM 410 located at a particular casino using mobile application 408, a certain amount of funds may be automatically allocated to a virtual user sub-account 471 associated with that casino before being transferred to a casino account 468 associated with that casino in order to ensure that appropriate limits and fees 467, for example, may be applied to this transaction. Similarly, if the customer earns credit from the casino (e.g., by winning a prize using EGM 410), funds may be transferred from casino account 468 associated with the casino to a corresponding virtual user sub-account 471.

Notably, any transfers between virtual accounts, are implemented by generating records within ledger 406, while all the funds remain stored in FBO account 426 (shown in FIG. 4A). Thus, use of traditional transfer systems and protocols and associated fees are not necessary for these virtual transactions, such as those between virtual user sub-accounts 471 and casino accounts (indicated by arrows 475) in implementations in which casino accounts are virtual accounts associated with actual funds stored in FBO account 426.

Casino accounts 468 may be associated with different respective casino properties, with each casino property having its own ledger account. For example, if a casino operator has twelve properties, each of the twelve properties may have at least one of its own casino account 468. For example, as shown in FIG. 4D, casino accounts 468 may include a first casino account 476 (“Casino A-1”), a second casino account 477 (“Casino A-2”) that are associated with a first casino operator, and a third casino account 478 (“Casino B-1”) that is associated with a second, different casino operator.

During the course of a predefined period (e.g., a day), debits and credits between customer accounts 466 and casino accounts 468 are recorded in ledger 406, and at the end of the period, these debits and credits may be settled to account for all the transfers during the period. For example, if a casino associated with a virtual casino account 468 has experienced a net loss for the period, virtual casino account 468 may have a negative balance, and an operator associated with this virtual casino account 468 may be required to make an actual transfer of funds from an external account into FBO account 426 to cover this negative balance. In some embodiments, this transfer may be performed automatically. On the other hand, if there is a positive balance within a virtual casino account, an operator associated with the account may be able to withdraw at least some of this balance, resulting in an actual transfer of this value from FBO account 426 to an external account associated with the operator.

FIG. 4E is a block diagram 479 illustrating ticket processing functions of UWS 401 (shown in FIGS. 4A and 4B). Mobile application 408 may include a mobile application server 480 as part of cloud-based components 402. WBE 409 is programmed in accordance with a plurality of rules 481, and may be connected via network 302 to a ticket server 482 which may include a ticket database 483 configured to store ticket information and a table 484 including organized ticket information, such as which types of transactions qualify for awarding of a ticket. Rules 481 may be stored in a memory of WBE 409 or a memory associated with WBE 409. WBE 409 may be configured to manage the ticket awarding process, including but not limited to ticket issuance and verification of tickets 485, as well as issuance of corresponding alerts 486 regarding issuance of tickets and winning tickets. WBE 409 may include a ticket issuance module 487, a ticket verification module 488, and/or an alert module 489. Ticket verification module 488 may verify that a ticket should be awarded for a certain transaction based on rules 481. For example, verification module 488 may perform a look-up in table 484 regarding a list of transactions that have been labeled as triggering awarding of a ticket to confirm that a given transaction qualifies for the awarding of a ticket. Once verified, ticket issuance module 487 may issue a ticket to the corresponding user, and cause a corresponding entry reflecting the issued ticket to be added to table 484 and/or ledger 406.

WBE 409 (and mobile app 408) may also be in communication via network 302 with a progressive server 490 which may include a progressive database 491 for storing information relating to the progressive bonus. Progressive server 490 may manage the progressive bonus and communicate when the drawing is happening and how much the award is. Progressive server 490 may manage a wide area progressive bonus system that can be used by users of the digital wallet system (e.g., mobile app 408) to reward and incentivize use of the digital wallet system as described herein. Progressive database 491 may also include information relating to each casino participating in the wide area progressive, as well as rules of the progressive.

WBE 409 (and mobile app 408) may further be in communication via network 302 with a transaction server 492 which may include a transaction database 493 for storing transaction data and user data 494. Transaction data may include a date/time a certain transaction was made, information of the user that made the transaction, and the type of transaction (e.g., a transaction at a gaming machine, table, and/or partner such as a restaurant, hotel, or other off-premises partner (e.g., retailer)). User data 494 may include data that links a player with a certain transaction, such as an account number or other identifier capable of linking a user to a transaction. Such transaction data and user data 494 may be listed within ledger 406. Orchestrator 442 may be programmed to manage and facilitate exchange of transaction data of transaction database 493 and user data 494 with ledger 406 and/or with WBE 409, for example for purposes of awarding tickets to players and displaying such awarded tickets within mobile app 408. In some embodiments, ledger 406 may store both transaction data and player information such as player information derived from user data 494, and such player information may be pulled from ledger 406 and mapped to issued tickets 485. Each of ticket database 483, progressive database 491, and transaction database 493 may store therein corresponding rules. Ticket database 483 may include ticket rules 495 which may govern ticket-related aspects such as the numbering scheme of ticket identifiers of issued tickets. Progressive database 491 may include progressive rules 496 which may define various aspects of the progressive bonus, including information pertaining to each casino participating in the progressive, funding rules, an amount contributed to the progressive for each qualifying play/transaction, and/or a duration of the progressive. Transaction database 493 may include transaction rules 497 which may define which transactions trigger the awarding of a ticket.

In some embodiments, transfer orchestrator 442 may be configured as an “on-premises” wallet system (e.g., a wallet transfer orchestrator) of a casino, in communication with ledger 406. Such a configuration enables a bonus system such as the wide area progressive bonus described herein to cover multiple independent and separate casinos. This represents just one example of a configuration that is capable of achieving such functionality, and other configurations may be utilized.

While various components in FIG. 4E are shown as separate, in some embodiments the components may be integrated. For example, ticket server 482, progressive server 490, and transaction server 492 may be integrated as one server containing multiple databases (e.g., databases 483, 491, 493) and the corresponding rules (e.g., rules 495, 496, 497) therein. As another example, rules 495, 496, 497 may be included within rules 481 of WBE 409. Ledger 406 may be stored in transaction database 493 or in a separate database (not shown). These servers and databases may be configured in a centralized manner. For example, in some embodiments, to map a single player database record to multiple venues, a user's top-level virtual account may be stored in a system primary account in association with different player loyalty identifiers/account across multiple venues, so that there is a single player database record within a certain country or other jurisdictional boundaries. As such, the configuration shown in FIG. 4E is not limiting.

Rules 481 may include a plurality of rules governing issuance of tickets, including fixed rules as well as temporary rules. Fixed rules may be rules that generally stay the same over time. For example, a casino operator may have a rule that awards a player a ticket for 30 minutes of play on any one game, or some cumulative amount of time representing an entire casino gaming session or total time spent playing plural EGMs, for example. Another example of a fixed rule may be awarding a ticket for a certain spend threshold (e.g., $100, or $100 within a certain time period). Temporary rules may include rules directed to temporary promotions. For example, a casino operator may want to promote a new game and entice players to a play the new game, and may incentivize users to do so by awarding extra tickets for play of the new game. Similarly, a casino operator may want to promote a certain on-premises restaurant or hotel, and award extra tickets for purchases made by players at that particular restaurant or hotel. Yet further, promotions may be tied to off-premises stores, where if a player makes a purchase at a certain third party affiliate store, they will be awarded with extra tickets. These are examples of rules included in rules 481 and are not limiting. Other rules may include ending a bonus session duration if a certain amount of tickets have been awarded, or after the progressive bonus has reached a certain dollar amount. Rules 481 may also include progressive bonus drawing timelines, other scheduling rules, and any other rules relating to the generation, management, verification, and/or distribution of tickets and any awards associated therewith. Rules 481 may further include rules (or instructions) regarding how WBE 409 may interface with other components of PBAS 400, such as game payments gateway 464, mobile application 408, and other components of cloud-based components 402. Rules 481 may be stored in a rules database, table, or the like, such as being stored within cloud-based components 402.

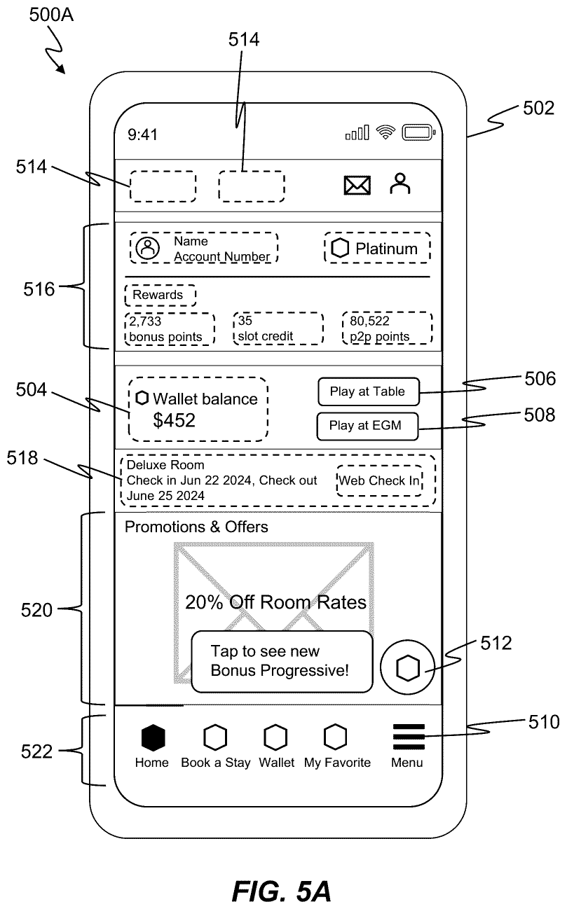

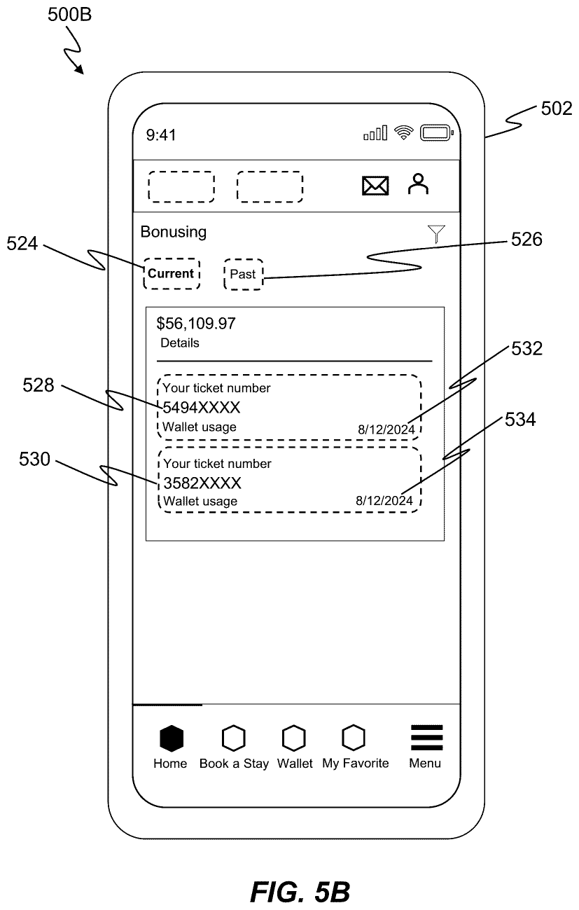

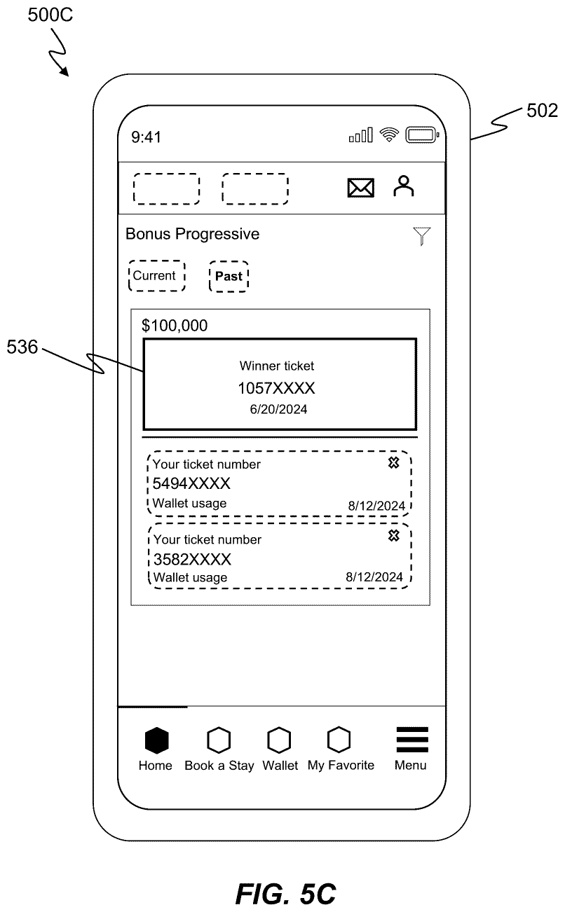

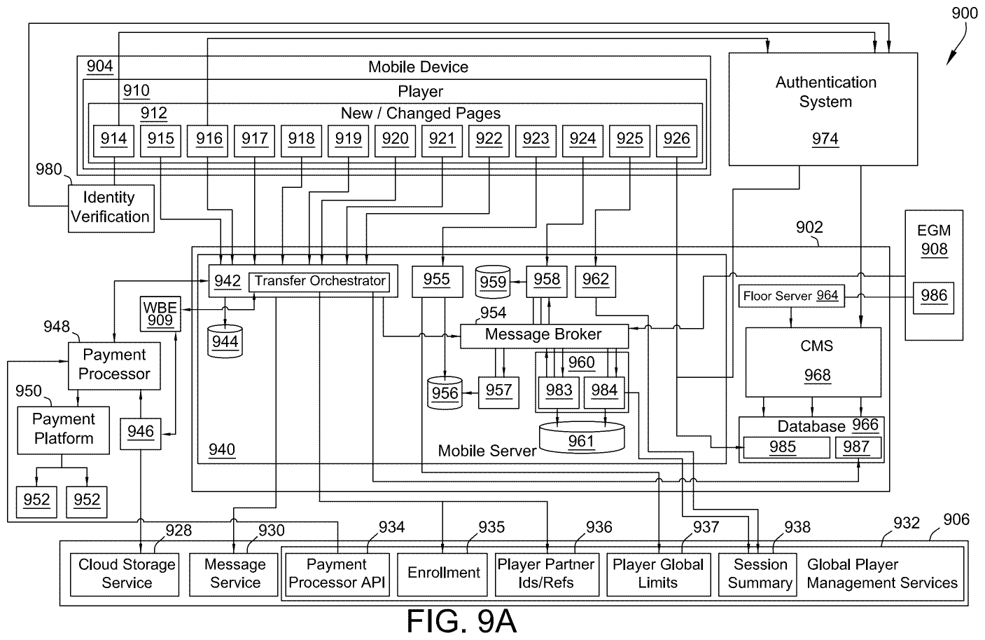

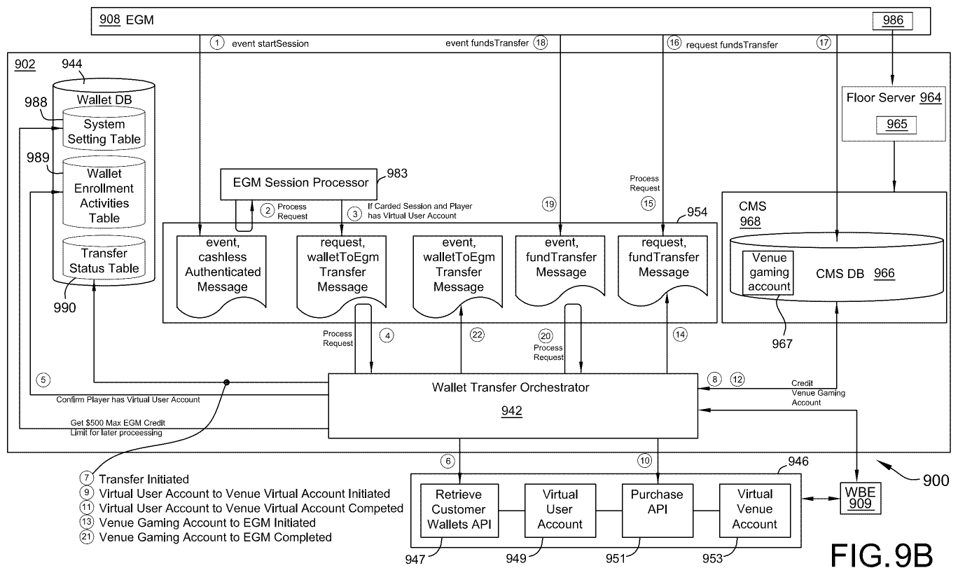

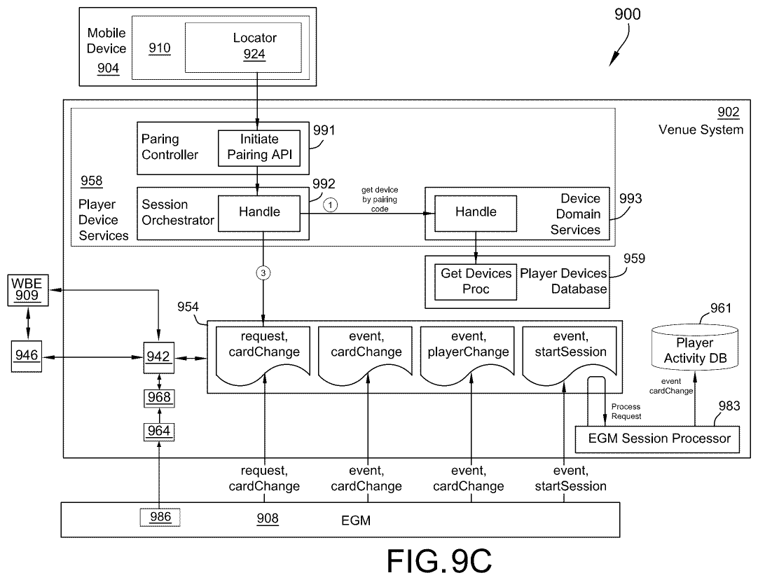

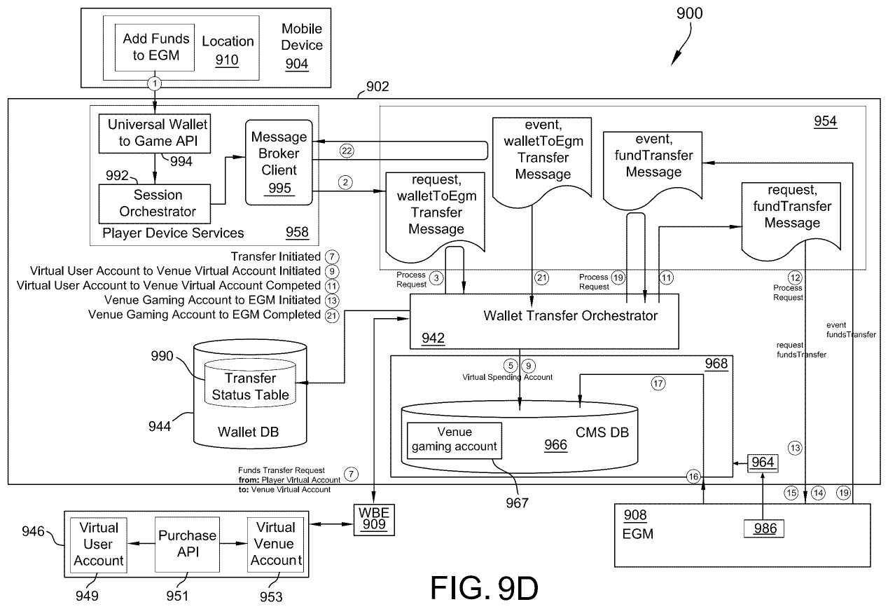

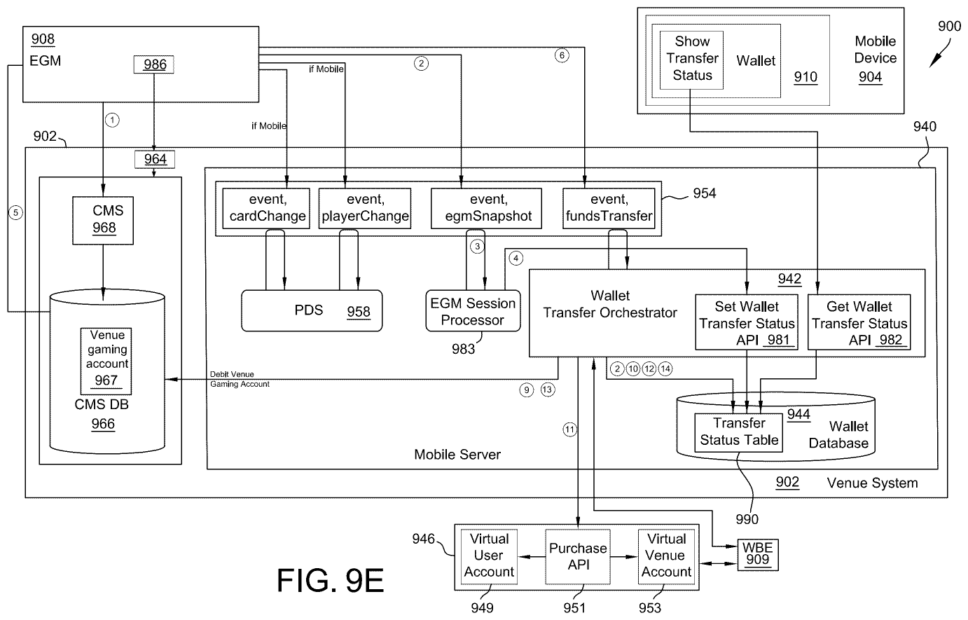

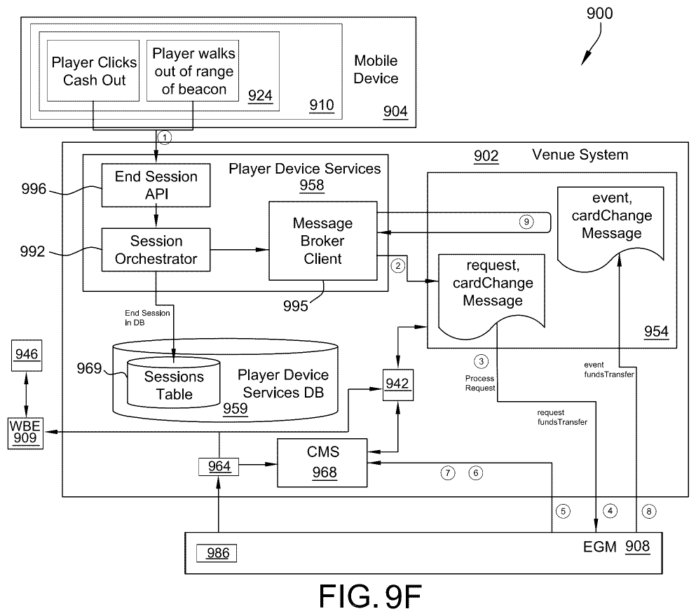

Further regarding the orchestration/management of tickets 485 by WBE 409, tickets may be issued to the player upon determining that a transaction is performed using the mobile app 408 (e.g., for an off-premises transaction), at a casino property 452 participating in the progressive bonus award, and/or at a gaming machine of a set of gaming machines of a plurality of gaming machines at a casino property participating in the progressive bonus award, and/or as otherwise described herein. Transactions may be determined in the manner shown and described herein, such as in connection with FIG. 4E (and also FIGS. 9A-9F, described below). A ticket 485 issued to the player may include a unique ticket identifier (e.g., ticket number 528/530 in FIG. 5B, described below) that may be randomly generated using an RNG such as RNG 212. Details of an awarded ticket 485 issued to the player to may be added to ticket database 483 upon a ticket 485 being issued to the player. An entry regarding such details may be added to table 484 of ticket database 483, linking the ticket identifier of the ticket issued to the player with that player, and the entry may include other ticket details such as a ticket issue date (e.g., 532/534 shown in FIG. 5B, described below) and/or a ticket issue time, the type of transaction that caused the ticket to be issued to the player (e.g., purchase, usage-based, etc.), and so on.

Within PBAS 400, ticket information is stored and distributed to ensure efficient and proper operation of the wide area progressive. The transaction tracking and ticket issuance processes may be performed in conjunction with ledger 406 and/or orchestrator 442. For example, in one embodiment, player information (e.g., player information associated with transaction data) may be extracted from ledger 406 and mapped to issued tickets 485. Data of the mapped tickets 485 and the player information may be stored in ledger 406. More generally, ledger 406 may be updated on a rolling basis with new transaction and ticket data, and ledger 406 and/or orchestrator 442 and/or some combination thereof may map the winning ticket information to the correct (e.g., winning) player.

In some embodiments, after each transaction is made and listed in ledger 406, an evaluation by WBE 409 may be performed to determine if the transaction qualifies for a ticket. If the transaction did not qualify for a ticket, a “NO” entry may be entered into ledger 406 in association with the corresponding transaction (or no entry may be made in ledger 406). A “NO” entry may list information regarding why no ticket was awarded (e.g., transaction not made at a participating entity or outside the timeframe of a given progressive bonus session). If the transaction qualifies for a ticket, a “YES” entry may be entered into ledger 406 indicating that the transaction qualified for a ticket and that a ticket was awarded for that same transaction. A “YES” entry may list information of why the transaction was a qualifying transaction (e.g., at valid participating entity and within timeframe of given progressive bonus session). In doing so, ledger 406 will have an accurate accounting not only of transactions, but also of any tickets awarded from qualifying transactions. Winning ticket information may also be caused to be listed in ledger 406 so that a history of winning tickets is retained within ledger 406. Orchestrator 442 may be programmed to interface with ledger 406 for providing the transactions and/or ticket information to be listed in ledger 406, in conjunction with servers 482, 490, and/or 492 and the respective databases (483, 491, 493), rules (495, 496, 497), and/or other data (e.g., such as user data 494 and tables such as table 484) stored therein.

A winning ticket number may be selected from the pool of tickets entered into the active progressive bonus, where the winning ticket number may be generated using an RNG call via an RNG such as RNG 212 that randomly pulls a ticket from amongst the known ticket numbers that entered into the progressive bonus for any given bonus session. Verification of that winning ticket may include comparing and matching the number of the issued ticket with the number of the drawn ticket, which may be performed by verification module 488 by way of a look-up in ticket database 483. An alert 486 may be sent by alert module 489 to a user computing device (e.g., a device including mobile app 408 thereon or otherwise accessible, such as mobile device 502 shown in FIGS. 5A to 5C, described below) of the player owning the ticket with the winning ticket identifier, and/or to other users that had entered into the same progressive bonus. Alerts 486 may be implemented as an alert 486 that may appear in the user interface of mobile application 408, a push notification received via a messaging feature of an operating system of the user computing device, and/or via a text message based alert if a user opts-in for such communications, and the like.

FIGS. 5A to 5C are exemplary screenshots or user interfaces 500A to 500C of a mobile application (e.g., 408) used by a player for tracking the progressive bonus award in accordance with some embodiments of the present disclosure. By way of a non-limiting example, the mobile application may be a digital wallet application, as described herein. As shown in the exemplary screenshot 500A, the mobile application may be executing as a frontend application on a mobile device 502 of the player, which may be similar to EUDs 300A, 300B, and 300C described above with respect to FIG. 3, for example. While a mobile application is mentioned in the present disclosure for the player, for example, to join the progressive bonus award and to track the progressive bonus award (e.g., details of tickets earned for the current transactions, details of tickets previously earned, details of a winning ticket, and/or a prize amount, and so on), the player may also (or alternatively) use a web browser application, and/or a native web application. Further, the mobile device 502 may be any electronic device (or any user computing device) such as a desktop, a laptop, a smartphone, a phone, a tablet, a smartwatch, and so on.

In FIG. 5A, a current wallet balance is displayed as 504, and affordances to the player to “Play at a Table” and to “Play at an EGM” are shown as 506 and 508, respectively. The player may perform transactions through the affordance 506 and/or the affordance 508 and earn tickets corresponding to the performed transactions. A menu option 510 may provide the player options, for example, to register to participate in the mobile app progressive bonus award, contribute funds to the progressive bonus award, and so on. The player may get details of the current status of the mobile app progressive bonus award by clicking on an icon that is shown as 512. Sections 514 of the mobile app user interface (UI) may be used to display names, logos, and/or other branding of casino entities (e.g., the entities associated with a current casino visit of the user) associated with the mobile app. Section 516 of the mobile app UI represents an account section, which may list the name, account number, and/or profile picture of the user, as well as the user's status level (e.g., “Platinum”), and rewards points information of the user, which may indicate available bonus points, slot credits, and p2p (e.g., person-to-person) points levels. Section 518 of the mobile app UI represents a hotel stay section, which may indicate a duration of a hotel stay and provide a check in button. Section 520 of the mobile app UI represents a “Promotions & Offers” section, providing display of available promotions and offers (e.g., “20% Off Room Rates” for hotel stays). Icon 512 may be included in section 520. Section 522 represents a mobile app navigation section, and may include selectable icons associated with various screens of the mobile app such as a “Home” screen, a “Book a Stay” screen, a “Wallet” screen, a “My Favorite” screen, and menu option 510, each which may open up to a more detailed/dedicated screen. For example, selection of the “Wallet” icon may take the user to a more detailed “Wallet” screen within the mobile app which displays more information than shown by current wallet balance 504. In some embodiments, selection of the icons in section 522 may cause an overlay screen of the selected icon to appear on top of the underlying screen. The mobile app UI shown in FIG. 5A may be representative of the “Home” page of the mobile app. The sections (e.g., 518, 520, 522) and other icons (e.g., 512) shown in FIG. 5A are merely examples of one embodiment of the mobile app interface, and may be used as sections representing other topics or aspects outside of those described above.

Upon the player clicking on the icon 512, as shown in the exemplary screenshot 500B, the player may view details of tickets earned through currently performed transactions (or transactions performed on the today's date) by selecting a button labeled as 524 (e.g., a “Current” button), and/or the player may view details of tickets earned through previously performed transactions (e.g., transactions performed within the last 7 days or 1 month) by selecting a button labeled as 526 (e.g., a “Past” button). Details of the ticket displayed to the player may include a ticket number (e.g., ticket identifier) which is shown in FIG. 5B as 528 and/or 530, a date when the player received ticket as shown in FIG. 5B as 532 and 534 along with corresponding transaction type (e.g., wallet usage, etc.) that caused the player to earn the ticket. When a winning ticket number is drawn, the winning ticket number may be displayed to the player, as shown in the exemplary screenshot 500C, as 536. In addition to the winning ticket number, a date (and time) when the winning ticket number is randomly drawn may also be displayed. The player who owns the winning ticket number may also see a full progressive pool award value or a partial progressive pool award value added to the player's digital wallet balance. The ticket functions and operations shown in and described in connection with FIGS. 4A to 4D and 5A to 5C may at least in part be performed by a game controller such as game controller 202.

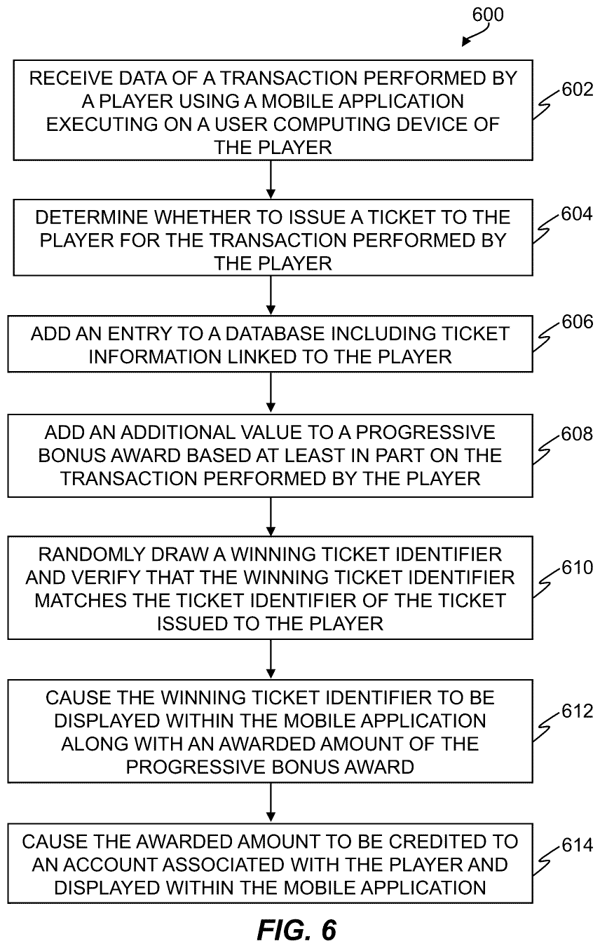

FIG. 6 is a flowchart illustrating an exemplary method 600 managing the progressive bonus award. The method 600 may be performed at a computing device such as an application server that is connected with a database, and various electronic gaming machines and/or other POS at one or more casino properties participating in the progressive bonus award. The progressive bonus award is associated with a mobile application such as a digital wallet application as described herein. Accordingly, the progressive bonus award system executing the exemplary method 600 is integrated within a mobile application. The mobile application may be executing on a user computing device of a player as described herein. The mobile application may be a digital wallet application as described herein.

The method 600 may include receiving (602) data of a transaction performed by a player of a plurality of players using the mobile application executing on the user computing device of the player. This may include data processing and other determinations between ledger 406, WBE 409, orchestrator 442, and/or servers 482, 490, and 492 as described herein. In some embodiments, the data of the transaction performed by the player may be received from a web browser-based application, and/or a native web application. The transaction performed by the player may be any transactions such as playing a game at an EGM using the frontend application, purchase of food or drink at a casino property, a hotel, an airport, and so on, for example. Depending on the received data for the transaction, and in response to determining that the player is participating in the progressive bonus award that is associated with the mobile application, determination (604) may be made whether to issue a ticket to the player for the transaction performed by the player. Such determination may be made in the manner described herein in connection with FIG. 4E. By way of a non-limiting example, and as described herein, the ticket may be issued to the player upon determining that the transaction is performed at a casino property participating in the progressive bonus award, and/or the transaction is performed at a gaming machine of a set of gaming machines of a plurality of gaming machines at a casino property participating in the progressive bonus award. The ticket issued to the player may include a ticket identifier. Each ticket may have a unique ticket identifier that may be randomly generated using an RNG such as RNG 212.

The method 600 may include adding (606) details of a ticket issued to the player to a database such as ticket database 483 shown in FIG. 4E upon the ticket being issued to the player. An entry may be added to the database linking the ticket identifier of the ticket issued to the player with the player, and/or to ledger 406 as described herein. In addition, the entry may include ticket details such as a ticket issue date and a ticket issue time, a transaction which caused the ticket to be issued to the player, and so on. The method 600 may include adding (608) an additional value to the progressive bonus award based at least in part on the transaction performed by the player to progressively increase the progressive bonus award during a promotional time period. The progressive bonus award may be created using seed capital by a casino property participating in the progressive bonus award. Additionally, or alternatively, additional value may be added to the progressive bonus award based at least in part on an increase in participation to the progressive bonus award by new players joining the progressive bonus award. As a result, the progressive bonus award may also be progressively, or gradually, increase during a promotional time period.

The method 600 may include randomly drawing a winning ticket identifier and verifying (610) that the winning ticket identifier is issued to any player of the plurality of players, for example as shown and described in connection with FIG. 4E. By way of an example, the winning ticket identifier may be randomly drawn using an RNG such as RNG 212 and compared with the ticket identifiers issued to the plurality of players. The ticket identifiers issued to the plurality of players may have been generated via an RNG such as RNG 212, or issued according to some other protocol. For example, ledger 406 may keep a running tally of all ticket identifiers, from ticket identifier 00000001 through ticket identifier XXXXXXXX. In response to determining that the winning ticket identifier is not issued to any player of the plurality of players, the progressive bonus award may be moved to a next level. However, in response to determining that the winning ticket identifier is issued to the player, the method 600 may include causing the winning ticket identifier to be displayed (612) within the mobile application along with an award amount of the progressive bonus award, and causing the awarded amount to be credited (614) to an account associated with the player, for example in the manner shown and described in connection with FIG. 4E. The amount credited to the account associated with the player may also be displayed within the mobile application of the player. Additionally, or alternatively, an alert notification may be sent to the user computing device of the player owning the ticket with the winning ticket identifier. The alert notification may advise the player that the player has won the progressive bonus award. Alerts may also be sent to other users indicating that a winning ticket has been drawn and the progressive bonus award has been won. Upon the progressive bonus award being won, a new progressive bonus award may start. An alert may be sent to other users of the mobile application as well, via messaging features of the mobile application, regarding a start of the new progressive bonus award. For example, with respect to FIG. 5A, the alert indicating a new bonus progressive may appear in section 520. Alerts may also be sent via push notifications and the like to mobile devices of the users. For example, alerts may be sent to users that had entries in the most recently won progressive bonus, or to other users based on other factors (e.g., time between last entry, etc.).

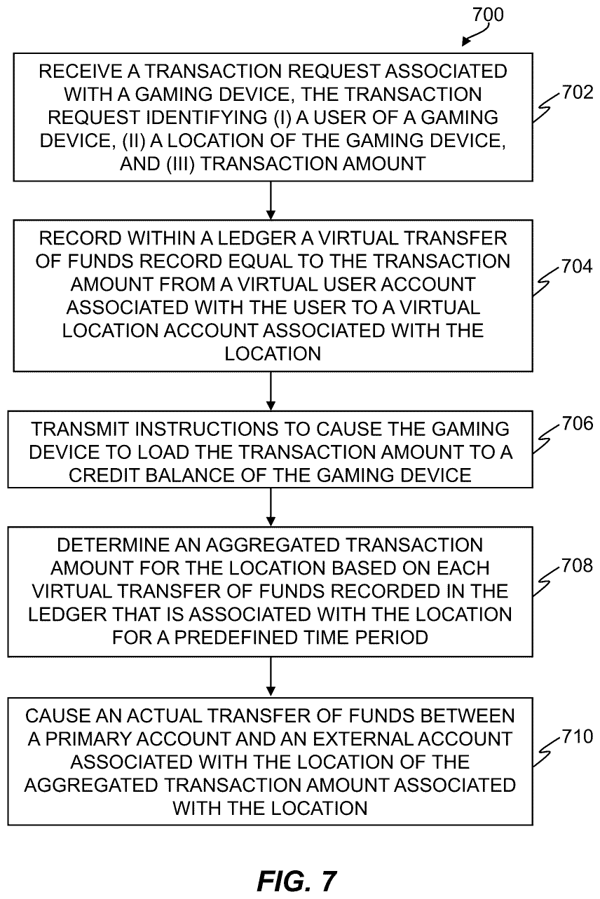

FIG. 7 is a flowchart illustrating an exemplary method 700 for transferring funds to EGM 410 using UWS 401 in a closed-loop transaction that does not result in a transfer of actual funds from FBO account 426.

Method 700 may include receiving (702) a transaction request associated with EGM 410 (e.g., from proxy board 416). The transaction request may identify (i) a user of EGM 410, (ii) a location (e.g., a particular casino site) of EGM 410, and (iii) a transaction amount (e.g., an amount the user wishes to transfer to a credit balance of EGM 410). In addition to EGM 410, similar transaction requests may be received from, for example, integration devices 425 to facilitate transactions at table games 420, cages 422, and/or on-premises POS 424.

Method 700 may further include in response to receiving the transaction request, recording (704) in ledger 406 a virtual transfer of funds record equal to the transaction amount from a virtual user account associated with the user to a virtual location account associated with the location of EGM 410. For example, ledger 406 may record a virtual user account associated with the user and another account associated with the location and may record a virtual transfer between the user's account and the location's account without actually transferring funds in or out of FBO account 426. This record of the transaction stored in ledger 406 may be immutable.

Method 700 may further include transmitting (706), for example to proxy board 416, instructions to cause EGM 410 to load the transaction amount to a credit balance of EGM 410. For example, if the user's account includes sufficient funds to cover the transaction amount, a cashless payment system associated with the location may be used to transfer funds from a venue gaming account associated with the location to EGM 410.

Method 700 may further include determining (708) an aggregated transaction amount for the location based on each virtual transfer of funds recorded in the ledger that is associated with the location for a predefined time period.

Method 700 may further include causing (710) an actual transfer of funds, between FBO account 426 and an external account associated with the location (e.g., an account associated with the casino operator), based on the virtual transfer of funds record associated with the location. In some embodiments, this actual transfer may be performed in aggregate with, for example, all the funds transfers for the location associated with a plurality of users for a predefined time period. Accordingly, for on-site closed loop transactions, funds transfers from FBO account 426 may be performed only periodically (e.g., once a day), rather than for each transaction.

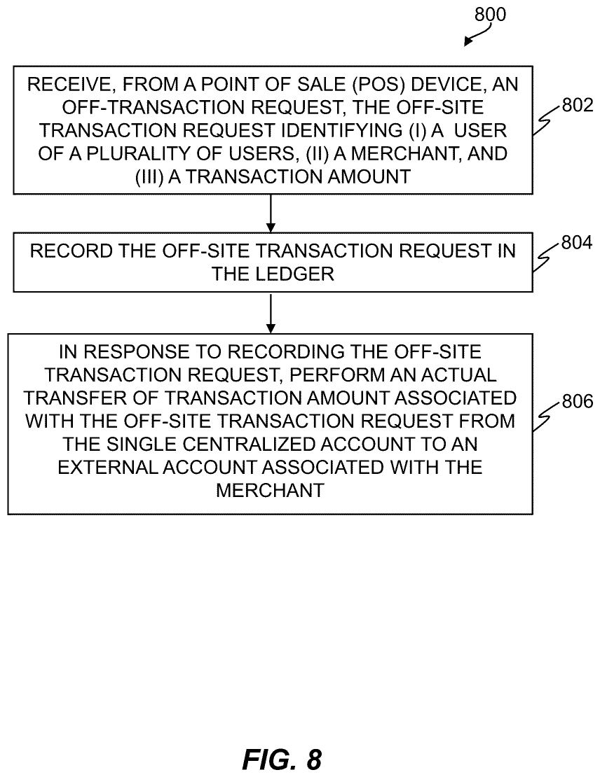

FIG. 8 is a flowchart illustrating an exemplary method 800 for off-site or open-loop transactions using UWS 401, for example, using debit card 430. Unlike the closed-loop transaction described above with respect to FIG. 7, this open-loop transaction may result in a corresponding transfer of actual funds.

Method 800 may include receiving 802, from an off-premises POS 428, an off-site transaction request, the off-site transaction request identifying (i) a user of the plurality of users, (ii) a merchant, and (iii) a transaction amount. The transaction request may be generated in response to, for example, a card swipe or chip input at a POS terminal or an input of debit card information to an online site.

Method 800 may further include recording 804 the off-site transaction request in ledger 406. For example, ledger 406 may record a sub-account associated with debit card 430, and record a deduction of the transaction amount from this sub-account. This transaction request recorded in ledger 406 may be immutable.

Method 800 may further include, in response to recording the off-site transaction request, causing 806 an actual transfer of a transaction amount associated with the off-site transaction request from FBO account 426 to an external account associated with the merchant. This contrasts from the closed loop transactions described with respect to method 700 shown in FIG. 7. Nonetheless, both open loop and closed loop transactions may be performed by the same UWS 401, in some cases, using debit card 430.

FIG. 9A illustrates an example overview of certain components and services of a gaming system 900 that may provide a digital wallet system according to an example embodiment of the present disclosure. At least some of the components of gaming system 900 may be executed, for example, by server computers 102 of FIG. 1. In some exemplary embodiments, gaming system 900 is similar to PBAS 400 (shown in FIGS. 4A and 4B, for example). Gaming system 900 includes a venue system 902, one or more mobile devices 904, a cloud system 906, and at least one EGM 908. Venue system 902 is configured to communicate with mobile device 904, cloud system 906, EGM 908, and WBE 909. WBE 909 may be the same as or similar to WBE 409 described herein.

Mobile device 904 may be configured to execute a mobile application 910, which may be configured to cause mobile device 904 to display one of a plurality of pages 912 through which a user may input information to and/or view information received from venue system 902 and/or cloud system 906. Mobile application 910 may be the same as or similar to mobile application 408 described above and shown in FIG. 4A. Some examples of pages 912 include a wallet enroll page 914, a player home page 915, a sign-in page 916, a link external account page 917, a frequently asked questions (FAQ) page 918, a funds transfer page 919, a payout page 920, a wallet home page 921, a transaction history page 922, a responsible gaming (RG) limits page 923, a locator page 924, an activity summary page 925, and/or a self-exclusion page 926, which are described in further detail below.

Cloud system 906 may include a cloud storage service 928, a message service 930, and a global player management service 932. Cloud storage service 928 may provide data storage for various components of gaming system 900, and message service 930 may enable internet-based communication between remote components of gaming system 900. Global player management service 932 may be capable of providing player management services across multiple venues and/or operators, and may include a plurality of services including, for example, a payment processor API 934, an enrollment service 935, a player partner ID service 936, a player global limits service 937, and/or a session summary service 938, which are described in further detail below. As described in further detail below, global player management service 932 may map a single player database record to multiple venue database records (e.g., records stored at different venue systems 902), thereby enabling a user's activity to be tracked across many different venues.

Venue system 902 may include a mobile server 940 configured to fulfill requests received from and provide information to mobile application 910. Mobile server 940 may include a wallet transfer orchestrator 942 and a wallet database 944 in communication with wallet transfer orchestrator 942. Wallet transfer orchestrator 942 may be used in conjunction with WBE 909 so that tickets for purchases that qualify for awarding of a ticket(s) are properly coordinated. Wallet transfer orchestrator 942 is further in communication with a ledger 946 and payment processor 948. Ledger 946 may function similarly to ledger 406 described above with respect to FIGS. 4A to 4E, 5A to 5C, and 6-8, and in some embodiments, may be managed by a third party (e.g., an entity separate from that managing venue system 902 and/or cloud system 906) and/or be stored in a remote location (e.g., using cloud storage service 928). Ledger 946 may be used in conjunction with WBE 909 so that tickets for purchases that qualify for awarding of a ticket(s) are properly verified and coordinated. For example, a verification module such as verification module 488 may be used to analyze and compare information in ledger 946 to ensure proper awarding of tickets. WBE 909 may operate according to rules such as rules 481 describes herein, which may also include rules (or instructions) regarding how WBE 909 interfaces wallet transfer orchestrator 942, ledger 946, and/or other components of gaming system 900. Payment processor 948 may be, for example, a payment card processing entity, ACH, or other entity capable of facilitating electronic payments, and may be in communication with a payment platform 950 (e.g., a payment card interchange network), which enables payment processor to settle funds between accounts at banks 952 based on transactions recorded immutably in ledger 946, as described above with respect to ledger 406. In some embodiments, transfer orchestrator 942 may be configured as an “on-premises” wallet system (e.g., a wallet transfer orchestrator) of a casino, in communication with ledger 946.

In addition to wallet transfer orchestrator 942, mobile server 940 may include other components configured to enable communication between venue system 902, mobile device 904, cloud system 906, and EGM 908. These components may include, for example, a message broker 954, a dynamic messaging module 955, a dynamic messaging database 956, a dynamic messaging listener 957, a player device module 958, a player device services database 959, a player activity module 960, a player activity database 961, and/or player activity APIs 962, which are described in further detail below.

Venue system 902 may further include a CMS database 966 which may include a venue gaming account 967 stored therein, and a player tracking system 968 (also referred to as CMS 968), which in some embodiments, may be incorporated into mobile server 940. In some embodiments, gaming system 900 may be CMS-agnostic, in that gaming system 900 does not require any integrated components of CMS 968 to be of a specific design, model, and/or manufacturer. For example, as described above with respect to UWS 401, gaming system 900 may include components capable of communicating with multiple different types of CMS 968.

In some embodiments, gaming system 900 further includes an authentication system 974 in communication with venue system 902, mobile device 904, and/or cloud system 906. Authentication system 974 may be configured to store confirmed identification data obtained from CMS 968 and may be used to verify identification data using, for example, messaging services (e.g., transmitting messages to and receiving confirmation from mobile device 904).

As described above, mobile application 910 may include wallet enroll page 914 through which a user may enroll with the digital wallet system. For example, the user may input identification information and/or information relating to financial and/or casino loyalty accounts associated with the user. Mobile device 904 may communicate with an identity verification server 980, which may verify the user's identity and eligibility to enroll with the digital wallet system using information retrieved from, for example, watchlists and/or government databases. The user may enter identification data using mobile application 910, and mobile application 910 may query identity verification server 980 to verify that the user's purported identity is accurate. Wallet transfer orchestrator 942 may use this data to create records associated with the user in wallet database 944, and, when funding is provided, corresponding user accounts may be generated in ledger 946 as described above with respect to FIG. 4D. This identification and enrollment information may be further stored and/or verified by cloud system 906 using, for example, enrollment service 935 and/or player partner ID service 936.

Mobile application 910 may further include player home page 915, which may be an initial page displayed upon opening mobile application and which may provide links to other pages 912 within mobile application 910, the same as or similar to that shown in FIGS. 5A to 5C. In some embodiments, player home page 915 may display a current wallet status and/or balances. Mobile application 910 may retrieve this information from wallet database 944 and/or ledger 946 by communicating with wallet transfer orchestrator 942.

Mobile application 910 may further include sign-in page 916, which may enable the user to sign into mobile application 910 to access the digital wallet system, for example, by entering a username and password. Once entered, this information may be compared to information stored, for example, in wallet database 944 and the user may be signed in if the information matches the corresponding records.

Mobile application 910 may further include link external account page 917, through which the user may link external bank accounts to the digital wallet system. Identifiers associated with these linked accounts (e.g., account numbers and/or routing numbers) may be stored in wallet database 944 in association with the corresponding user. These linked accounts may be used to transfer money into our out of the digital wallet system, with these transfers being recorded in ledger 946, and with money transferred into the account being stored in a universal account such as FBO account 426.

Mobile application 910 may further include FAQ page 918, which may be used to retrieve and display information to the user. For example, mobile application may retrieve information from wallet database 944 and/or ledger 946 to display a current wallet balance.

Mobile application 910 may further include funds transfer page 919, which the user may use to load a user-defined value of additional funds onto an EGM from the digital wallet system. These user-defined values may be stored in wallet database 944 and used by wallet transfer orchestrator 942 to execute funds transfers.

Mobile application 910 may further include payout page 920, which may be used by the user to withdraw money from the digital wallet system and transfer the money, for example, to a designated linked account. Though payout page 920, the user may specify an amount of money to withdrawn and a desired destination account. Based on this information, wallet transfer orchestrator 942 may instruct payment processor 948 to transfer the specified amount to the designated account and record this transfer and resulting change in balance in ledger 946.

Mobile application 910 may further include wallet home page 921, through which the user may view information relating to the digital wallet system. For example, mobile application may retrieve information from wallet database 944 and/or ledger 946 to display a current wallet balance. Wallet home page 921 may also serve as a default page and/or include links to other pages within mobile application 910.

Mobile application 910 may further include transaction history page 922 that enables the user to view a history of previous transactions. Because data relating to gaming and other transactions flows through message broker 542, as described in further detail below, dynamic messaging listener 957 may record data relating to these transactions in dynamic messaging database 956. When a request is made via mobile application 910, dynamic messaging module 955 may retrieve this data and transmit the data to mobile device 904 for presenting in transaction history page 922.

Mobile application 910 may further include responsible gaming limits page 923, through which a user may set spend limits and/or time limits (e.g., the user may only spend a certain amount or spend a certain amount of gaming within a predefined period). These specified limits may be communicated to and recorded with player global limits service 937 of cloud system 906. The user's playing activity may be tracked, based on data passed through message broker 954, at different respective venues by player activity module 960 and stored in player activity database 961. For example, player activity module may include an EGM session processor 983 that identifies activity (e.g., spending, time logged in and/or in an active gaming session) at EGMs such as EGM 908. Player activity module 960 may further include a global player publisher 984 that transfers this data to session summary service 938 at cloud system 906. Player global limits service 937 is able to access data this data, so that player activity across multiple different venues can be tracked and responsible gaming limits can be enforced at all connected venues based on this data.

Mobile application 910 may further include locator page 924, which may utilize player device data stored by player device module 958 in player device services database 959 to determine mobile device 904 is located at a particular venue associated with venue system 902.

Mobile application 910 may further include activity summary page 925 which enables the user to view a summary of playing activity across all venues associated with the digital wallet system. As described above, this activity may be stored by session summary service 938 based on data received from player activity module 960. Mobile device 904 may communicate with session summary service 938 via player activity APIs 962 to retrieve this activity data and display the data using activity summary page 925.

Mobile application 910 may further include a self-exclusion page 926, through which the user may view a self-exclusion status and/or which may control and/or alter functionality of mobile application 910 based on the user's self-exclusion status. For example, some or all of the functionality of the digital wallet system may be unavailable to self-excluded individuals. To determine this status, mobile device 904 may communicate with CMS database 966, which may include a self-exclusion list 985.

In some embodiments, EGM 908 is capable of providing at least some of the functions described with respect to pages 912 of mobile application 910.

EGM 908 may be configured to communicate with venue system 902. When a user wishes to initiate gameplay at EGM 908 using funds they have stored in a virtual account using the digital wallet system, the user may log into EGM 908 using their digital wallet system account and/or a linked casino loyalty account, swiping a loyalty card and/or otherwise provide information enabling the user's virtual wallet to be identified.

To load money from the digital wallet system onto EGM 908 to be used for gameplay, a gaming transaction may be initiated as described above. A transaction request may be transmitted from EGM 908 to wallet transfer orchestrator 942 via message broker 954. EGM 908 may include a floor communication module 986 configured to communicate with the floor via a floor server 964. For example, EGM 908 may communicate with the floor via floor server 964 in connection with a floor service that may offer a suite of benefits, and with a gaming limits module 965 that may store therein gaming limits data representing gaming limit thresholds that a player may enter via the mobile application (e.g., mobile application 408), and which may determine a venue response for when such limits are reached. Gaming limits module 965 may be part of floor server 964 (such as shown in FIG. 9B, for example), or provided within another component of system 900, such as another component within venue system 902, or within EGM 908. Floor server 964 may also be in communication with CMS 968. Wallet transfer orchestrator 942 may query wallet database 944 and/or ledger 946 to determine if there are sufficient funds associated with the user, and if so, virtual wallet may record a transfer of the funds from a virtual account associated with the user the user to a virtual account associated with an operator or venue associated with EGM 908 in ledger 946 (e.g., without a funds transfer between external accounts occurring). If a loyalty card is used, wallet transfer orchestrator 942 may perform a lookup in a card database 987 of CMS database 966 to identify the corresponding account. Wallet transfer orchestrator 942 may then transmit instructions to EGM 908, via message broker 954, to load the desired amount of credits. When the user desires to cash out at EGM 908, any remaining credits may be transferred back to the user in a similar manner, with ledger 946 being updated to record a transfer from the virtual account associated with the venue or operator to the virtual account associated with the user.

In some embodiments, mobile application 910 may be integrated with and/or connected to authentication system 974. In such embodiments, authentication system 974 may generate and store an authentication status of the user. Authentication system 974 may communicate with venue system 902, for example, to verify the user is not on self-exclusion list 985 and to facilitate gaming transactions using the digital wallet system similar to those described with respect to EGM 908. Authentication system 974 may interface with a wallet enroll page 914, sign-in page 916, and identity verification server 980 in connection with storage of enrollment data in CMS database 966, for example.

In some embodiments, certain types of use of gaming system 900 may trigger or require a payment of fees to an operator of gaming system 900. For example operators associated with venue system 902 and/or EGM 908 may pay one-time and/or periodic licensing fees, and/or fees may be applied to various transactions by users and/or operators, such as deposits, withdrawals, gaming transactions, and/or non-gaming transaction described herein.

FIG. 9B illustrates example components of gaming system 900 enabling a user enrolled with a digital wallet to starts session by inserting or otherwise entering a physical card at EGM 908 and starting a carded session. As shown in FIG. 9B, wallet database 944 may include system settings table 988, a wallet enrollment activities table 989, and a transfer status table 990, each of which may interface with wallet transfer orchestrator 942.

After the card is entered, a request to establish a session and to transfer credits to EGM 908 may be transmitted, via message broker 954, to EGM session processor 983, which may establish the carded session and verify that the user has a digital wallet account. If the session is established successfully, a request to transfer credits to EGM 908 may be transmitted to wallet transfer orchestrator 942, which may query wallet enrollment activities table 989 to confirm that the user has a digital wallet account and systems setting table 988 to ensure that the transaction does not exceed a predefined limit. Once this confirmation is made, wallet transfer orchestrator 942 may query ledger 946 to get a current balance associated with the digital wallet account. If the balance is sufficient to execute the transfer, wallet transfer orchestrator may then initiate a virtual transfer of funds from the user's digital wallet account to a venue account within ledger 946 and record this transfer in CMS database 966. Wallet transfer orchestrator 942 may then initiate a transfer from the venue account to EGM 908 using a cashless payment system, which may be recorded in CMS database 966, and may transmit instructions, via message broker 954, to EGM 908 to load the funds.

Each step of this transfer operation, such as (1) transfer initiated, (2) digital wallet user account to venue account initiated, (3) digital wallet user account to venue account completed, (4) venue account to EGM initiated, and (5) venue account to EGM completed, may be recorded in transfer status table 990. In this regard, ledger 946 may include various APIs such as a retrieve customer wallet(s) API 947 and a purchase API 951, and various accounts, such as a virtual user account 949 and a virtual venue account 953. Retrieve customer wallet(s) API 947 may be configured to assist with retrieving a wallet of a player, and purchase API 951 may be configured to assist with tracking purchases of a player. Virtual user account 949 may represent a virtual account of a player, and virtual venue account 953 may represent a virtual account of a venue.

In some embodiments, ledger 946 may include one or more virtual accounts such as virtual account 949 to track contributions made to the digital wallet or to progressives associated with only a single property (e.g., a single casino) (e.g., the same as or similar to virtual accounts 470 and 471 shown in FIG. 4D). For example, ledger 946 may also track what digital wallet bonus a player is qualified for.

FIG. 9C illustrates example components of gaming system 900 enabling a user associated with a digital wallet account to start a session using mobile application 910. As shown in FIG. 9C, player device module 958 may include a pairing controller 991 in communication with mobile device 904, a session orchestrator 992 in communication with message broker 954, and a device domain service 993 in communication with player device services database 959.

To initiate the session, mobile application 910 may provide a pairing code to pairing controller 991. Using this pairing code, device domain service 993 may query player device services database 959 to identify mobile device 904 and the associated user. Session orchestrator 992 may query CMS 968 to determine if the identified user has an active card. If so, session orchestrator 992 may transmit instructions via message broker 954 to EGM 908 to log in the user, and when confirmation of this login is received from EGM 908, EGM session processor 983 may record that a session is active in player activity database 961. Once the session is established, the user may initiate virtual transfers with the digital wallet system using EGM 908 in a similar manner as described with respect to FIG. 9B or using mobile application 910 as described in further detail below with respect to FIG. 9D.

FIG. 9D illustrates example components of gaming system 900 that enable a user to enter an amount to transfer via mobile application 910 after a mobile session has been created. As shown in FIG. 9D, player device module 958 may include a wallet-to-game API 994 in communication with mobile device 904, and may further include a message broker client 995 in communication with message broker 954.

When a session is established and the user enters a desired transfer amount via mobile application 910, a request to transfer credits to EGM 908 may be transmitted, via player device module 958 and message broker 954, to wallet transfer orchestrator 942. Wallet transfer orchestrator 942 may query ledger 946 to get a current balance associated with the digital wallet account. If the balance is sufficient to execute the transfer, wallet transfer orchestrator may then initiate a virtual transfer of funds from the user's digital wallet account to a venue account within ledger 946 and record this transfer in CMS database 966. Wallet transfer orchestrator 942 may then initiate a transfer from the venue account to EGM 908 using a cashless payment system, which may be recorded in CMS database 966, and may transmit instructions, via message broker 954, to EGM 908 to load the funds.

Each step of this transfer operation, such as (1) transfer initiated, (2) digital wallet user account to venue account initiated, (3) digital wallet user account to venue account completed, (4) venue account to EGM initiated, and (5) venue account to EGM completed, may be recorded in transfer status table 990.

FIG. 9E illustrates example components of gaming system 900 configured to end a session in response to the user removing a card, which may result in a cashing out of any funds remaining on EGM 908 to the user's digital wallet account. When the card is removed or the user otherwise logs off at EGM 908, CMS 968 may be notified via wallet transfer orchestrator 942, player device module 958, and EGM session processor 983 may be notified via message broker 954. The ending of the session may be recorded by EGM session processor 983, and wallet transfer orchestrator 942 may initiate a transfer of funds back to the user's digital wallet account. To execute this transfer, wallet transfer orchestrator 942 may transfer funds from EGM 908 to the corresponding venue account using the cashless payment system and record this transfer in CMS database 966 and ledger 946. Wallet transfer orchestrator 942 may then record a virtual transfer of the funds from the venue account to the user's digital wallet account within ledger 946.

Each step of this transfer operation, such as (1) transfer initiated, (2) EGM to venue account initiated, (3) EGM to venue account complete, (4) venue account to digital wallet user account initiated, and (5) venue account to digital wallet user account complete, may be recorded in transfer status table 990. In some embodiments, wallet transfer orchestrator 942 may communicate with mobile device 904 enabling this status to be displayed using mobile application 910. Additionally, wallet transfer orchestrator 942 may include various APIs, such as a set wallet transfer status API 981 and a get wallet transfer status API 982. Set wallet transfer status API 981 may be used for setting a wallet transfer status, and get wallet transfer status API 982 may be used for obtaining a wallet transfer status.

FIG. 9F illustrates example components of gaming system 900 configured to end a session in response to input received from the user using mobile application 910. As shown in FIG. 9F, player device module 958 may include an end session API 996 in communication with mobile device 904.

In response to the user selecting to cash out via mobile application 910 or mobile device 904 being moved out of range of a wireless beacon of EGM 908, mobile device 904 may transmit a message to end the session via end session API 996. The ending of the session may be recorded by session orchestrator 992 in player device services database 959, and message broker client may notify EGM 908 and CMS 968 via message broker 954 that the session has ended. In response, EGM 908 may log out the player, and a transfer of funds from EGM 908 to the user's virtual wallet may be executed as described with respect to FIG. 9E. Player device services database 959 may include a sessions table 969 that includes therein session data.

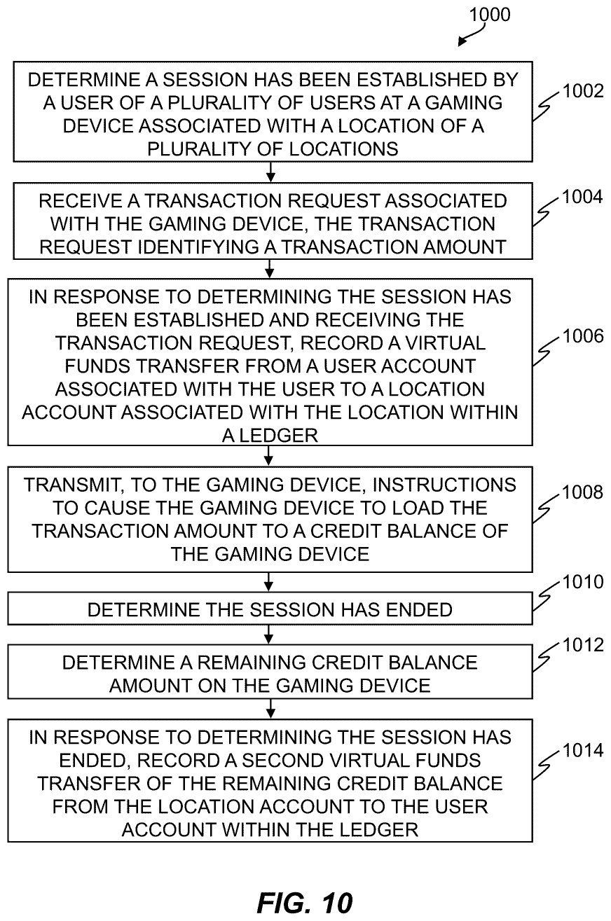

FIG. 10 is a flowchart illustrating an exemplary method 1000 for transferring funds to EGM 908 using gaming system 900, for example, by executing wallet transfer orchestrator 942 (all shown in FIG. 9A).

Method 1000 may include determining 1002 a session has been established by a user of a plurality of users at EGM 908, which is associated with a location of a plurality of locations and a corresponding venue system 902. To determine the session has been established, wallet transfer orchestrator 942 or another component of gaming system 900 may determine, for example, that a user card associated with the user has been entered at the EGM 908 or that a request to establish the session at EGM 908 from a mobile device 904 associated with the user executing mobile application 910.

Method 1000 may further include receiving 1004 a transaction request associated with EGM 908, the transaction request identifying a transaction amount such as a desired amount of credits to load onto EGM 908. The transaction request may be received from, for example, EGM 908 or mobile device 904 executing mobile application 910.

Method 1000 may further include, in response to determining the session has been established and receiving the transaction request, recording 1006 a virtual funds transfer from a user account associated with the user to a location account associated with the location within ledger 946.

Method 1000 may further include transmitting 1008, to EGM 908, instructions to cause EGM 908 to load the transaction amount to a credit balance of EGM 908. For example, a cashless payment system of CMS 968 may transfer funds from the location account to EGM 908.

Method 1000 may further include determining 1010 the session has ended. For example, to determine the session has ended wallet transfer orchestrator 942 or another component of gaming system 900 may determine the session has ended by determining a user card associated with the user has been removed at EGM 908, by receiving a request to end the session at EGM 908 from mobile device 904 executing mobile application 910, or by determining a mobile device associated with the user is not detected by a wireless beacon of EGM 908.

Method 1000 may further include determining 1012 a remaining credit balance amount on the gaming device, and, in response to determining the session has ended, recording 1014 a second virtual funds transfer of the remaining credit balance from the location account to the user account within the ledger.

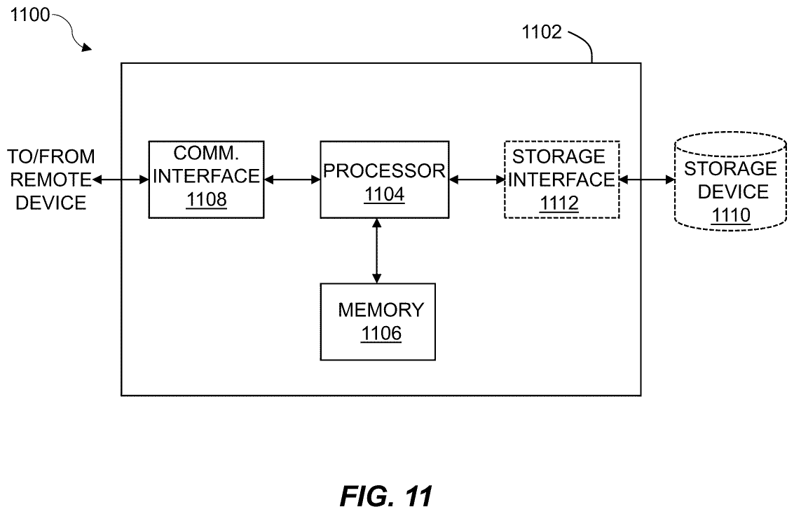

FIG. 11 illustrates an example configuration 1100 of a server computer 1102, which may be a configuration of server computers 102 (shown in FIG. 1) in accordance with one example embodiment of the present disclosure. Server computer 1102 includes a processor 1104 operatively coupled with a memory 1106. The various devices (e.g., 102) may communicate with other devices (e.g., remote devices) within PBAS 400 shown in FIG. 4A (or gaming system 900 shown in FIGS. 9A-9F) via a communication interface 1108 operatively coupled to processor 1104. In some embodiments, processor 1104 is operatively coupled to storage device 1110 via a storage interface 1112, to access or store data within storage device 1110. Storage device 1110 may be standalone storage or embodied as any storage device shown in and described in connection with FIGS. 1, 2A, 2B, and 3.

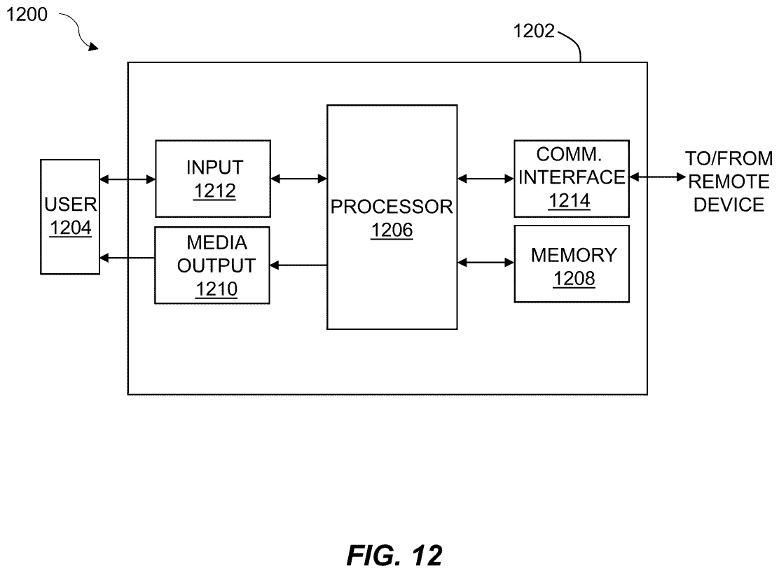

FIG. 12 illustrates an example configuration 1200 of user computing device 1202 such as EUDs 300A to 300C shown in FIG. 3 that includes mobile application 408 (shown in FIG. 4A, or mobile application 910 shown in FIG. 9A) thereon. User computing device 1202 of user 1204 includes a processor 1206 operatively coupled with a memory 1208. User computing device 1202 also includes at least one media output component 1210 for presenting information to user 1204. In some embodiments, user computing device 224 includes an input device 1212 for receiving input from user 1202. User computing device 1202 may further include a communication interface 1214 so that user computing device 1202 may communicate with other computing devices (e.g., remote devices) within PBAS 400 shown in FIG. 4A (or gaming system 900 shown in FIGS. 9A-9F). In some embodiments, media output component 1210 includes an output adapter such as a video adapter and/or an audio adapter. An output adapter is operatively coupled to processor 1206 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). Input device 1212 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1210 and input device 1212.

Each of the various communication interfaces (e.g., 1108, 1214) shown in and described in connection with FIGS. 11 and 12 may be communicatively couplable to a remote device such as a server system (e.g., 102) or a web server, and may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). For example, communication interfaces 1108 and 1214 may receive data from network 302 shown in FIG. 3.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A progressive bonus award system integrated within a mobile application, comprising:
a memory device storing instructions; and
a game controller comprising a processor configured to execute the instructions stored in the memory device, which, when executed, cause the game controller to:
receive, from a wallet orchestrator associated with the mobile application, data of a transaction performed by a player of a plurality of players using the mobile application executing on a user computing device of the player;
list the transaction data in a digital ledger associated with the mobile application, the transaction data including player information of the player;
in response to determining that the player is participating in a progressive bonus award associated with the mobile application, determine whether to issue a ticket to the player for the transaction performed by the player, the ticket including a ticket identifier and providing the player a chance to win the progressive bonus award;
in response to issuing a ticket to the player for the transaction performed by the player, add an entry to the digital ledger including ticket information of the issued ticket, the entry being linked to the player;
add an additional value to the progressive bonus award based at least in part on the transaction performed by the player to progressively increase the progressive bonus award during a promotional time period;
at the end of the promotional time period, randomly draw a winning ticket identifier of a winning ticket and verify that the winning ticket identifier matches the ticket identifier of the ticket issued to the player; and
provide, via the mobile application, notification of the winning ticket to at least the player.

2. The progressive bonus award system of claim 1, wherein one or more casino properties are associated with the progressive bonus award, and loyalty points corresponding to each of the one or more casino properties and belonging to the player may be exchanged for one or more additional tickets for entry into the progressive bonus award.

3. The progressive bonus award system of claim 2, wherein the loyalty points are convertible on a location-based basis corresponding to a location of each of the one or more casino properties.

4. The progressive bonus award system of claim 1, wherein an amount of the progressive bonus award increases in accordance with predefined quantities of tickets being awarded to the plurality of players.

5. The progressive bonus award system of claim 1, wherein the instructions stored in the memory device, which, when executed, further cause the game controller to issue one or more additional tickets to the player based on a badge level earned by the player.

6. The progressive bonus award system of claim 1, wherein the instructions stored in the memory device, which, when executed, further cause the game controller to create the progressive bonus award using seed capital provided by a casino property participating in the progressive bonus award.

7. The progressive bonus award system of claim 1, wherein the instructions stored in the memory device, which, when executed, further cause the game controller to identify and issue meta-awards to a player of the plurality of players who earned a highest number of tickets at each participating casino property during the promotional time period.

8. The progressive bonus award system of claim 1, wherein the wallet orchestrator is associated with the mobile application and configured as an on-premises wallet system of a casino property participating in the progressive bonus award and orchestrates the listing of one or more tickets issued to the player in the ledger.

9. The progressive bonus award system of claim 1, further comprising a ticket database and transaction database, wherein the instructions stored in the memory device, which, when executed, further cause the game controller to cause the issuance of the ticket to the player based on a result of a comparison made between the transaction data, a plurality of rules stored within the ticket database, and a plurality of rules stored within the transaction database.

10. The progressive bonus award system of claim 1, wherein transactions that qualify for awarding of a ticket include at least one from the group of: (i) the player downloading the mobile application; (ii) the player's usage of the mobile application; and/or (iii) the player transferring funds via one or more accounts associated with the mobile application.

11. A computer-implemented method for providing a progressive bonus award system integrated within a mobile application implemented using at least one processor with at least one memory, comprising:
receiving, from a wallet orchestrator associated with the mobile application, data of a transaction performed by a player of a plurality of players using the mobile application executing on a user computing device of the player;
listing the transaction data in a digital ledger associated with the mobile application, the transaction data including player information of the player;
in response to determining that the player is participating in a progressive bonus award associated with the mobile application, determining whether to issue a ticket to the player for the transaction performed by the player, the ticket including a ticket identifier and providing the player a chance to win the progressive bonus award;
in response to issuing a ticket to the player for the transaction performed by the player, adding an entry to the digital ledger including ticket information of the issued ticket, the entry being linked to the player;
adding an additional value to the progressive bonus award based at least in part on the transaction performed by the player to progressively increase the progressive bonus award during a promotional time period;
at the end of the promotional time period, randomly drawing a winning ticket identifier of a winning ticket and verify that the winning ticket identifier matches the ticket identifier of the ticket issued to the player; and
providing, via the mobile application, notification of the winning ticket to at least the player.

12. The computer-implemented method of claim 11, wherein one or more casino properties are associated with the progressive bonus award, and loyalty points corresponding to each of the one or more casino properties and belonging to the player may be exchanged for one or more additional tickets for entry into the progressive bonus award.

13. The computer-implemented method of claim 11, wherein an amount of the progressive bonus award increases in accordance with predefined quantities of tickets being awarded to the plurality of players.

14. The computer-implemented method of claim 11, wherein the wallet orchestrator is associated with the mobile application and configured as an on-premises wallet system of a casino property participating in the progressive bonus award and orchestrates the listing of one or more tickets issued to the player in the ledger.

15. The computer-implemented method of claim 11, further comprising causing the issuance of the ticket to the player based on a result of a comparison made between the transaction data, a plurality of rules stored within a ticket database, and a plurality of rules stored within a transaction database.

16. One or more non-transitory computer-readable storage media with a plurality of instructions stored thereon that, in response to being executed, cause a game controller to:
receive, from a wallet orchestrator associated with the mobile application, data of a transaction performed by a player of a plurality of players using the mobile application executing on a user computing device of the player;
list the transaction data in a digital ledger associated with the mobile application, the transaction data including player information of the player;
in response to determining that the player is participating in a progressive bonus award associated with the mobile application, determine whether to issue a ticket to the player for the transaction performed by the player, the ticket including a ticket identifier and providing the player a chance to win the progressive bonus award;
in response to issuing a ticket to the player for the transaction performed by the player, add an entry to the digital ledger including ticket information of the issued ticket, the entry being linked to the player;
add an additional value to the progressive bonus award based at least in part on the transaction performed by the player to progressively increase the progressive bonus award during a promotional time period;
at the end of the promotional time period, randomly draw a winning ticket identifier of a winning ticket and verify that the winning ticket identifier matches the ticket identifier of the ticket issued to the player; and
provide, via the mobile application, notification of the winning ticket to at least the player.

17. The one or more non-transitory computer-readable storage media of claim 16, wherein one or more casino properties are associated with the progressive bonus award, and loyalty points corresponding to each of the one or more casino properties and belonging to the player may be exchanged for one or more additional tickets for entry into the progressive bonus award.

18. The one or more non-transitory computer-readable storage media of claim 16, wherein an amount of the progressive bonus award increases in accordance with predefined quantities of tickets being awarded to the plurality of players.

19. The one or more non-transitory computer-readable storage media of claim 16, wherein the wallet orchestrator is associated with the mobile application and configured as an on-premises wallet system of a casino property participating in the progressive bonus award and orchestrates the listing of one or more tickets issued to the player in the ledger.

20. The one or more non-transitory computer-readable storage media of claim 16, wherein the instructions, in response to being executed, further cause the game controller to cause the issuance of the ticket to the player based on a result of a comparison made between the transaction data, a plurality of rules stored within a ticket database, and a plurality of rules stored within a transaction database.
